(19) United States
(12) Patent Application Publication
(10) Pub. No.: US 2006/0136291 A1
(43) Pub. Date: Jun. 22, 2006

(54) Vehicle managing method

(75) Inventors: Kenichi Morita, Hitachinaka (JP); Satoshi Sugawara, Kimitsu (JP); Kimiya Yamaashi, Hitachi (JP); Seiji Ukai, Koganei (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 11/339,150

(22) Filed: Jan. 25, 2006

Related U.S. Application Data
(63) Continuation of application No. 09/945,156, filed on Aug. 30, 2001, now abandoned.

(30) Foreign Application Priority Data
Feb. 15, 2001 (JP) 2001-037858
Mar. 1, 2001 (JP) 2001-056117

(51) Int. Cl. G07B 15/00; G08G 1/123; H04H 1/00; H04N 7/20; H04N 7/18; H04N 7/173; H04Q 7/20; G08B 1/08; G01M 17/00; B60Q 1/00

(52) U.S. Cl. 705/13; 725/66; 725/75; 725/86; 455/3.02; 455/427; 340/539.1; 340/995.13; 340/425.5; 701/29

(57) ABSTRACT

A vehicle overall interactive managing method is disclosed. Uplink information transmitted by way of an artificial satellite to a center includes emergency information and periodic information. Downlink information transmitted from the center via the artificial satellite to each vehicle includes audio and image. There is provided at a ground station a movable body overall information management system that is provided with databases storing various types of data and an analysis system. Mandatory automobile inspection information, user information, traffic and road information, safety information, and other types of information are distributed to each of information requiring organizations through this system.

### BACKGROUND OF THE INVENTION

The present invention relates to a method for collecting information on movable bodies by making use of a satellite communications system or other mobile telecommunications system (ground-based digital communications, cellular phones, DSRC, etc.).

There have been a number of car navigation systems put into practical use, which show on their screens where a vehicle is currently located, and later years have even witnessed a communications navigation system that connects cellular phones with car navigation systems.

A common means of obtaining vehicle status information is, instead of adopting a real-time system, to prepare part of historical data of a vehicle when the vehicle is inspected at a dealer and the data is transmitted to a committed automobile manufacturer or a vehicle parts manufacturer through cable telecommunications.

The existing vehicle insurance system employs a scheme of paying premiums on an annual contract basis regardless of frequency of utilization of the vehicle.

A system is available as a means of obtaining vehicle status information, in which part of historical data of the vehicle is acquired through cable connections when the vehicle is inspected at a dealer. Because of a low frequency of collection and uncertainty about the vehicle's being driven into a specific dealer for inspection involved in this method, it is difficult for a committed vehicle manufacturer or a parts manufacturer to make a statistical analysis of the data, set up a marketing plan for each model, and give feedback information to an upstream design function. To collect and manage data for each model of vehicles manufactured by a specific manufacturer through cellular phones, which have spread at a rapid pace as an embodiment of mobile telecommunications technology, it becomes necessary to have telephone numbers of all users and it is difficult to collect information from, and send information to, multiple specific vehicles.

Furthermore, since it is currently impossible to have statistical data on utilization of vehicles, users have no choice but to conclude an annual contract with a nonlife insurance company regardless of the frequency of utilization of the vehicle, making it impossible to pay insurance premiums in proportion to utilization frequency and utilization status, and in accordance with many varied other needs.

When a used vehicle is assessed, the assessment made is not solid at all, being carried out by simply filling out a check sheet and exchanging photos. It is therefore difficult to evaluate vehicle conditions in terms of aspects other than appearance based on data available from vehicles of the same model, same model year, and similar mileage.

It has not therefore been common practice at all to collect information on current vehicle conditions continuously on a real-time basis, or if it has ever been so, it has been concerned only with a limited, narrow area and the information collected in this manner could never be useful. Continuously collecting information on vehicle conditions is indispensable to a statistical analysis of the vehicle and model. Without such statistics, no diagnostic analysis can be made.

### SUMMARY OF THE INVENTION

It is therefore an object of the invention to provide, in terms of vehicle insurance, a method for processing vehicle insurance premium charge that allows an insured person to pay premiums in accordance with frequency and conditions of utilization of a vehicle by continuously collecting information on current vehicle conditions in details, positively, and on a real-time basis and making a statistical analysis thereof.

It is also another of the invention to provide, by taking the opportunity of making this proposal, a comprehensive interactive vehicle management method that makes it possible to provide information providing organizations with vehicle information in areas other than insurance and, at the same time, provide vehicle users with various broadcasting and communications information.

According to one aspect of the present invention, a vehicle managing method includes the steps of distributing music and/or image through a satellite to each of vehicles with which a contract for music distribution and/or image distribution has been made, or distributing information in one category, or two or more categories, selected from among music, image, navigation, road and traffic, emergency, and new vehicle information categories, and at the same time, receiving periodic information on each of the contracted vehicles therefrom via the satellite, analyzing the received information for each vehicle, and transmitting the analysis information to a predetermined recipient of the analysis information.

Preferably, the periodic information may be on, for example, at least one of the followings; namely, the position, speed, direction, and condition of the vehicle. It would be particularly practical if the periodic information is driving time data and via point data representing geographical points, areas, or routes through which the vehicle moves that would be obtained by combining the different types of information noted earlier. In addition to the periodic information transmitted to the satellite from each of the contracted vehicles, it is desirable that emergency information concerning the vehicle be also transmitted. Preferably, possible recipients of the analysis information are selected from among groups of an insurance company, road maintenance company, supervisory agency, governmental organization, vehicle management company, vehicle maintenance company, and vehicle dealer. It is even more desirable that the information transmitted from vehicles at periodic intervals be stored in a storage medium at an interval shorter than the predetermined interval for the periodic information and accumulated data be transmitted in a batch at the predetermined interval.

A preferred artificial satellite system applied to the invention is, for example, one that uses a non-geostationary satellite that is in a highly elliptic orbit, as that incorporated in European Patent Laid-open No. 0880240A2. This elliptic orbit system has the minimum elevation angle over the service area is not less than 40°, for the purposes of sharing with terrestrial services.

Typical operations of transmission and reception of information carried out in the vehicle managing method according to the invention may be as follows.

(1) Vehicle position information is found and collected by using a signal reflected off an artificial satellite after the signal has been transmitted thereto through an antenna provided in a controlled vehicle, and information on a condition of each individual vehicle is collected by transmitting vehicle control information or vehicle parts condition information from the controlled vehicle to the artificial satellite through the antenna provided in the controlled vehicle and receiving a signal reflected off the artificial satellite or by transmitting the information by way of DSRC (dedicated short range communication; the same abbreviation of DSRC is to be used hereunder) or a mobile communications device including a cellular phone and receiving the transmitted signal.

(2) Vehicle position information is found and collected by using a signal reflected off an artificial satellite after the signal has been transmitted thereto through an antenna provided in a controlled vehicle, information on the conditions of each individual vehicle is collected by transmitting vehicle sensor information to the artificial satellite through the antenna provided in the controlled vehicle and receiving a signal reflected off the artificial satellite or by transmitting the information by way of DSRC or a mobile communications device including a cellular phone and receiving the transmitted signal, and individual vehicle information is collected together with vehicle body information including a vehicle model and serial number, as well as user information unique to the controlled vehicle separately input.

(3) Vehicle position information is found and collected by using a signal reflected off an artificial satellite after the signal has been transmitted thereto through an antenna provided in a controlled vehicle, information on a condition of each individual vehicle is collected by transmitting vehicle control information and vehicle parts condition information from the controlled vehicle to the artificial satellite through the antenna provided in the controlled vehicle and receiving a signal reflected off the artificial satellite or by transmitting the information by way of DSRC or a mobile communications device including a cellular phone and receiving the transmitted signal, and individual vehicle information is collected by transmitting vehicle condition information extracted from a diagnostics system mounted in the controlled vehicle, based on a command issued by the diagnostics system to transmit diagnostics results information, from the controlled vehicle to the artificial satellite and receiving a signal reflected therefrom, together with vehicle body information including a vehicle model and serial number, as well as user information unique to the controlled vehicle separately input.

(4) Information on a condition of each individual vehicle is collected by transmitting vehicle control information or vehicle parts condition information from a controlled vehicle to an artificial satellite through an antenna provided in the controlled vehicle and receiving a signal reflected off the artificial satellite.

(5) Information on a condition of each individual vehicle is collected by transmitting vehicle sensor information to an artificial satellite through an antenna provided in a controlled vehicle and receiving a signal reflected off the artificial satellite, and vehicle body information including a vehicle model and serial number, as well as user information unique to the controlled vehicle separately input.

(6) Information on a condition of each individual vehicle is collected by transmitting vehicle control information and vehicle parts condition information from a controlled vehicle to an artificial satellite through an antenna provided in the controlled vehicle and receiving a signal reflected off the artificial satellite and by transmitting vehicle condition information extracted from a diagnostics system mounted in the controlled vehicle, based on a command issued by the diagnostics system to transmit diagnostics results information, from the controlled vehicle to the artificial satellite and receiving a signal reflected therefrom, together with vehicle body information including a vehicle model and serial number, as well as user information unique to the controlled vehicle separately input.

The vehicle managing method according to the invention further provides the following system. Namely, position information, speed information, vehicle condition information (information on an engine and electrical and mechanical system), and safety and crisis management information are collected from the vehicle on a real-time basis. These pieces of data are managed overall and analyzed to identify a vehicle operation management status, readiness to ensure safety and cope with hazardous situations, traffic congestion status, and utilization of the vehicle, thereby building a mobile information overall management system that provides various kinds of services. While providing transportation companies, road maintenance agencies, vehicle manufacturers, and traffic information providers with charged data, the overall information management system has the transportation companies, road maintenance agencies, and vehicle manufacturers distribute individual information to each vehicle. It is preferable, in this system, that a contract governing information exchange be concluded between the mobile information management system and the vehicle users, and between the mobile information management system and transportation companies, road maintenance agencies, and vehicle manufacturers, thereby allowing the mobile information management system to earn the wherewithal to sustain itself from the contracts. It is further preferable, in this system, that the mobile information management system be run with enhanced convenience for the vehicle users by letting the mobile information management system broadcast music or image, in addition to enabling interactive communications.

In addition, preferably, information obtained from vehicles may be analyzed by the mobile information management system and, if a vehicle trouble is anticipated, that information is passed onto not only the corresponding driver, but also the vehicle manufacturer or a designated dealer including a maintenance service shop so that the designated dealer may dispatch a technician who is capable of performing repair and service jobs to a location specified by the driver and who may carry with him or her service and replacement parts as necessary to perform a quick service job at the specified location. It is preferable in this system that operation characteristics of the driver be analyzed to calculate the insurance premiums.

If the invention is to be applied to insurance charging, it is an object of the invention to find and collect vehicle position information by classifying vehicle condition information into two groups, namely, the vehicle position information and other information which may, for example, include vehicle control information, vehicle parts condition information, vehicle body information, user information, and vehicle maintenance and historical information, and by using a signal reflected off the artificial satellite after the signal has been transmitted thereto through an antenna provided in the vehicle. The signal reflected off the artificial satellite after it has been transmitted thereto through the antenna has conventionally been used to find a vehicle position for use in navigation; however, it has never been done to collect and analyze the obtained vehicle position information. Moreover, if the invention is to be applied to insurance charging, it is practical to allow a statistical analysis to be made of both vehicle position information and other vehicle information combined by collecting other information in addition to vehicle position information. The foregoing two means make it possible to accumulate detailed and positive vehicle information about each individual vehicle on a real-time basis, permitting application to vehicle insurance premium charging processing.

Furthermore, if the invention is to be applied to insurance charging, a method is executed in which driving time data for a predetermined period of time (which could be one day) of a contracted vehicle is collected and statistically analyzed and via point data representing geographical points, areas, or routes through which the vehicle has been driven (hereinafter referred generically to points) is collected and analyzed, thereby permitting payment of insurance premiums in accordance with vehicle utilization frequency and conditions. One of the most important points that are realized through executing the method is that it permits deferred payment of insurance premiums that vary in accordance with vehicle utilization frequency and condition, instead of the conventional advance payment on an annual contract basis. It goes without saying that it is possible to revise existing contracted premiums using the data collected and analyzed as described heretofore.

The following specific methods may be applied if the invention is to be embodied in insurance charging. That is, in a vehicle insurance premium charging processing method in which vehicle insurance premiums established and charged according to a contract concluded with the vehicle user, driving time for a predetermined period of time of a contracted vehicle is collected and via points data representing points through which the contracted vehicle has been driven is collected; charging time data is established based on the driving time and a weighting of insurance premiums is established based on the charging time data or via point data, or both, thereby displaying the amount charged as insurance premiums based on the charging time data, via point data, and insurance premium weighting. The insurance premium weighting is a premium rate. The via point data includes points registered as being known, points yet to be registered because they are unknown, and points registered as being accident-ridden, and a low insurance premium weight is assigned to the points registered as being known and a high insurance premium weight is assigned to the points yet to be registered because they are unknown and points registered as being accident-ridden. For the purpose of the weighting of insurance premiums, vehicle control information, vehicle parts condition information, user information or maintenance and historical information concerning the vehicle and user, and other information are to be used. Furthermore, points are calculated using the charging time and weighted via point data and the premium rate and insurance money are determined based on the points obtained through calculation.

An embodiment of the invention is as follows. That is, in a charged service system in which basic information of music and image is distributed to a vehicle and fees are collected from viewers-listeners, information transmitted from the vehicle is collected at an overall information center which, in turn, analyzes the information and transmits it to vehicle management organizations, road management organizations, and insurance organizations, and information from these management centers is transmitted to vehicles, thereby improving service functions for the viewers-listeners and consequently raising the fees for the charged services.

A first embodiment of data analysis is concerned with a position, speed, and direction of a vehicle of the information provided by the vehicle. The information representing these pieces of data is collected from all vehicles on the road at predetermined intervals, which identifies a traveling speed of vehicles on each traffic, thus showing the condition of traffic congestion. When combined with information provided by the road management center, the information helps enhance accuracy of traffic congestion information. A vehicle driver, on the other hand, can have information on congestion conditions of not only nearby places, but also a remote destination and is allowed to obtain from the road management organization detour information and traffic information on roads which are less congested. It is also possible, by analyzing information provided by the vehicles located in tunnels, bridges, or road sections under construction, to detect any unusual conditions present in these areas. By adding time-of-day factor to these information, it is possible to analyze characteristics of utilization of vehicles by users, that is, whether the vehicles are used for weekend vacationing in resorts, for day-to-day shopping, or for nighttime driving or business. This serves as useful data for vehicle dealers when they make recommendations for vehicle models as customers decide to buy new ones next time. It is also possible to analyze driving habits and characteristics of the driver, including application of sudden braking and whether he or she tends to rev up to the maximum speed. This provides useful data not only for the vehicle dealer, but also for the insurance company for making a danger prediction analysis of the driver in its effort to reduce premium rate for good drivers.

A second embodiment of data analysis uses information provided from the vehicle, particularly the amount of fuel still available for use and mileage. Since the amount of fuel still available for use and mileage allow an analysis to be made of fuel economy of the vehicle, the vehicle management organization can use the data for evaluating the vehicle and improving performance. If such data is made available to users, it means that data for selecting vehicles is disclosed, thus enhancing convenience for the users.

A third embodiment of data analysis uses information provided from the vehicle, particularly exhaust gases (CO₂, CO, NO, NO₂, SO₂, and amounts of soot and other particles). The condition of the vehicle is identified by analyzing exhaust gases therefrom and the user is informed of whether the vehicle needs maintenance, or oil or a part needs replacement. The vehicle management organization is then provided with data that allows an analysis to be made of engine conditions and specific road conditions affecting vehicle characteristics, thus making use of data in developing new vehicles and improving existing ones.

A fourth embodiment of data analysis uses information provided from the vehicle, particularly conditions in which an air bag is activated, collision acceleration speed, vehicle tilt (the vehicle is considered to be rolled over if tilted to a predetermined angle or more), and an emergency communication (button or voice) made from the driver. Such information, as it contains data representing an unusual condition or emergency of the vehicle, allows the vehicle management center or road management center to resort to emergency mobilization.

A fifth embodiment of data analysis permits continuous collection of information of the following types, since information furnished by the vehicle can be stored in a storage medium by taking readings at much shorter intervals and transmitted in a batch at predetermined intervals. Namely, since it is possible to collect detailed information on vehicle speed, vehicle direction, acceleration, number of times the brake is applied, and vehicle-to-vehicle distance (measured using a radar), the information is useful in making an analysis in even greater detail of the driving habits and characteristics of the user noted earlier. The analysis of such information permits an accurate analysis of the route the vehicle has followed, which makes it possible to gain information on road conditions in even greater detail.

A sixth embodiment of data analysis uses traffic congestion analysis information as the information provided from the vehicle. Thanks to these pieces of information, the road management center can identify specific spots at which, and particular time bands during which, traffic congestion tends to occur, thereby providing vehicle users with appropriate congestion bypass prediction information before they run into the jam. The users, on the other hand, can use traffic congestion prediction information to select a route and a time band to bypass congestion, which as a result contributes to easing traffic congestion.

A seventh embodiment of data analysis is to analyze operating information of a company's fleet, figure out an optimum deployment of the fleet, and formulate an operating schedule. Managing the operating condition of a company's fleet optimizes vehicle operation and cargo loading control. It is also possible to instruct a vehicle on what to do next by making use of advantages of interactive communications. Health care and safety operation management is also possible, including instructing a driver to take a rest through driver's tiredness check.

An eighth embodiment of data analysis is concerned with driver's tiredness check. A driver may be advised to take a rest to ensure utmost safety through monitoring of driving conditions, or the movement of eyeballs, and driver's tiredness as determined by checks on turning of the steering wheel, acceleration, and braking. A driver's tiredness check and a check for dozing off at the wheel, made based on a vehicle-to-vehicle distance determined with a radar and the number of sudden brakes applied, are analyzed to allow an accident preventive function that warns the driver before an accident actually happens to be exhibited. The interactive communication function is used to allow the center to send an emergency transmission of warning data such as a buzzer.

While the invention will be described in its preferred embodiment in vehicles, it is understood that the invention is applicable to other movable bodies including ships. Furthermore, although reception at movable bodies is mandatory, it does not exclude a case in which information is received by fixed terminals including homes.

According to the invention, it is preferable that periodic information be received once in 5 to 10 minutes (at which intervals, it is possible to determine traffic on the road based on the distance traveled by the moving object). Considering the time it takes the periodic information to be transmitted (even with a lag of 1 to 2 minutes), there is no problem involved since the information being transmitted is appended with the time of measurement. It is further possible to change the frequency in the middle of operations (which requires a command issued from a master station).

### BRIEF DESCRIPTION OF THE DRAWINGS

FIG. 1 is a conceptual diagram showing an interactive satellite communications service system according to an embodiment of the invention;

FIG. 2 is a conceptual diagram showing a case of providing traffic congestion information in the above system according to the embodiment of the invention;

FIG. 3 is a diagram of a typical screen presenting congestion information employing the embodiment of the invention;

FIG. 4 is a diagram showing a typical record of driver's actions employing the embodiment of the invention;

FIG. 5 is a diagram showing a typical screen presenting part of statistical traffic information employing the embodiment of the invention;

FIG. 6 is a characteristic diagram showing the results of simulation of call loss probability employing the embodiment of the invention;

FIG. 7 is a timing chart showing a transmission/reception relationship between a movable body and a ground station according to the embodiment of the invention;

FIG. 8 shows a diagram of status transition on the ground station side in FIG. 7;

FIG. 9 shows a diagram of status transition on the movable body side in FIG. 7;

FIG. 10 is a conceptual diagram showing a typical movable body overall information management system according to the embodiment of the invention;

FIG. 11 is a conceptual diagram showing a typical movable body overall information management system according to the embodiment of the invention;

FIG. 12 is a conceptual diagram showing interactive communications operations performed by the system embodying the invention;

FIG. 13 is a diagram showing interactive communications operations performed by the system embodying the invention;

FIG. 14 is a diagram illustrating basic functions offered by the transmission/reception terminal of the system embodying the invention;

FIG. 15 is a conceptual diagram showing another system embodying the invention;

FIG. 16 is a block diagram showing the functions of an on-vehicle device;

FIG. 17 is a block diagram showing the functions of a centralized management center;

FIG. 18 is a conceptual diagram showing a satellite communications broadcasting system according to the embodiment of the present invention;

FIG. 19 is a flowchart showing a vehicle condition online managing method according to the embodiment of the present invention;

FIG. 20 is a flowchart showing a vehicle information providing service method according to the present invention of the invention; and

FIG. 21 is a block diagram showing the flow of information services and contract fees in the basic business of “music/broadcast+interactive communication.”

### DETAILED DESCRIPTION OF THE PREFERRED EMBODIMENYS

Hereinafter, a vehicle managing method according to an embodiment of the invention will be described with reference to the accompanying drawings.

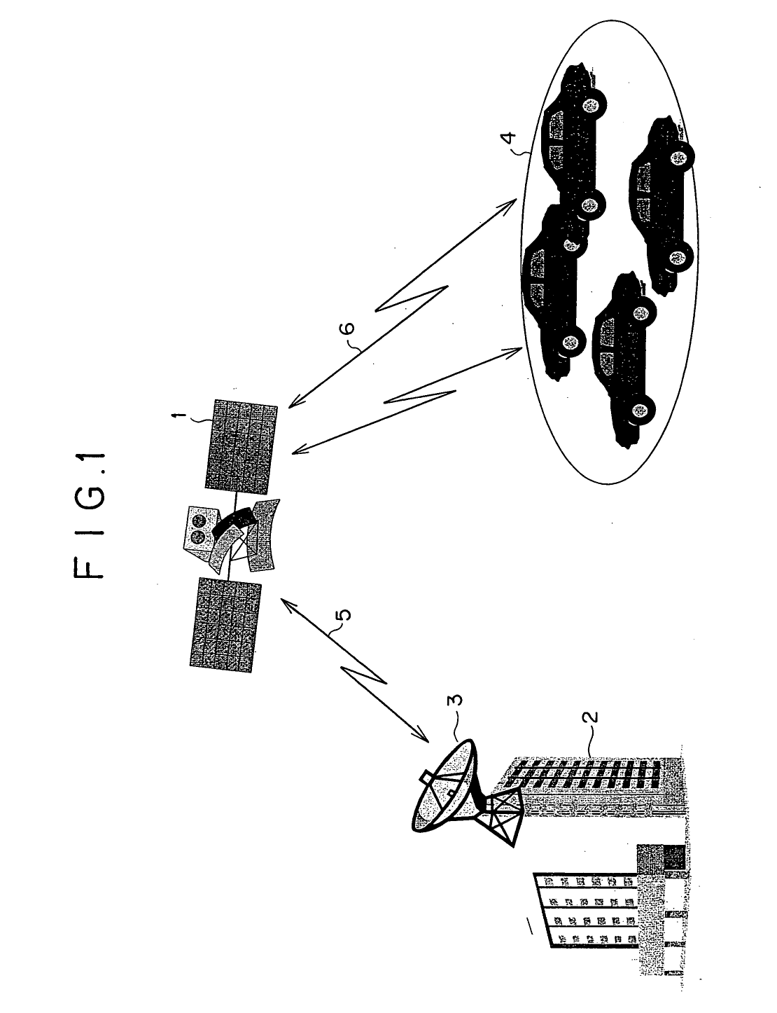

FIG. 1 is a schematic drawing showing the concept of an interactive satellite communications service used in the invention. This service allows interactive communications 6 to be carried out between an artificial satellite 1 and each of contracted vehicles 4 and interactive communications 5 to be carried out between a service center 2 and the artificial satellite 1 via an antenna 3. Though named a communications system, it may distribute image and music by broadcasting. The same holds true hereunder in this specification.

The service center 2 provides the following services under this system. (1) Providing traffic congestion information: A trajectory of a local vehicle is compared with statistical information and traffic of a scheduled route is predicted. A typical communications band (from a vehicle to the center) required for this service is several kbps multiplied by the number of vehicles. (2) Managing vehicle locations: This represents a control of vehicle movements to enable highly efficient management through giving delivery instructions. A typical communications band (from a vehicle to the center) required for this service is several kbps multiplied by the number of vehicles. (3) Telemetry service: Various types of control information are collected through the vehicle and the information is provided by way of a network. A typical communications band (from a vehicle to the center) required for this service is also several kbps multiplied by the number of vehicles. (4) Charging system: This represents user control including restricted reception and e-commerce. A typical communications band (from a vehicle to the center) required for this service is, at most, several bps multiplied by the number of vehicles. (5) Audi/image communications: This represents audio and image communications carried out in accordance with MPEG, AAC, and other standard format. A typical communications band (from the center to a vehicle) required for this service is several hundred kbps multiplied by the number of programs. (6) Security service: An application of the emergency information system (Help Net), this service requires a communications band (from a vehicle to the center) of several kbps multiplied by the number of vehicles.

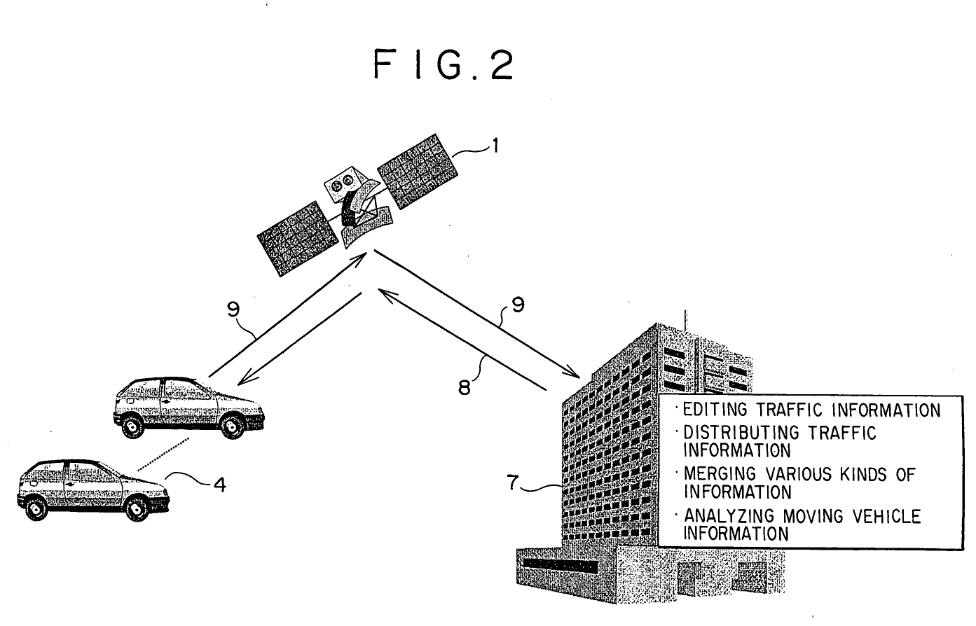

Referring to FIG. 2, a case of providing traffic congestion information is described as an example of uplink applications. In this case, the center 2 in FIG. 1 may, for example, be a traffic congestion information center 7. The center 7 edits traffic information, distributes traffic information, merges various types of information, and analyzes moving vehicle information. Communications are interactive between the center 7 and a satellite 1. To be more specific, traffic information 8 is transmitted from the center 7 to the satellite 1, while moving vehicle data 9 is received at the center 7 by way of the satellite 1. The traffic information 8 is delivered to each of contracted vehicles 4 via the satellite 1, while the moving vehicle data 9 is derived from each of the contracted vehicles 4. Each vehicle is an authorized member or a probe car (with which road and traffic information is determined). Each vehicle is, in a nutshell, supposed to gather moving vehicle data (position, speed).

To describe this example as applied to a case in Japan, suppose that all areas of Tokyo metropolitan trunk roads are covered for real-time information with an average information update interval of 5 min. Base on the average vehicle speed of about 20 km/h in the Kanto seaside district (taken from Metropolitan Tokyo Regional Disaster Prevention Plan HP), the distance traveled for 5 min. is 20×5/60=1.67 km and the total length of Tokyo metropolitan national highways and municipal highways is 2,625.0 km (as of Apr. 1, 1998), a total of 5,250 km to count roads up and down in both directions (2,625.0×2). To obtain real-time information, it would be effective if there are available 5,250/1.67=3,150 vehicles. An estimated number of moving vehicles at any given point in time on Tokyo metropolitan trunk roads is obtained as follows: namely, average density×total length of roads=traffic/average speed×total length of roads=[13,190 (traffic for 12 hours)/12/20]×5,250=288,531 vehicles. Then, probe car ratio γ=3,150/288,531=1.09% and, if probe cars are placed at predetermined intervals, it is preferable that the probe car ratio be two to three times as large as 1.09% when they are placed at random. Considering the fact that there are only part of vehicles equipped with on-board terminals running on the roads and suppose that the number of vehicles in operation in the Tokyo metropolitan area (as of the end of 1996, excluding two-wheeled vehicles and special-purpose vehicles) is 4,108,109, it is effective if the number of terminals is as follows; namely, the number of vehicles in operation×probe car ratio=4,108,109×1.09/100=44,778.

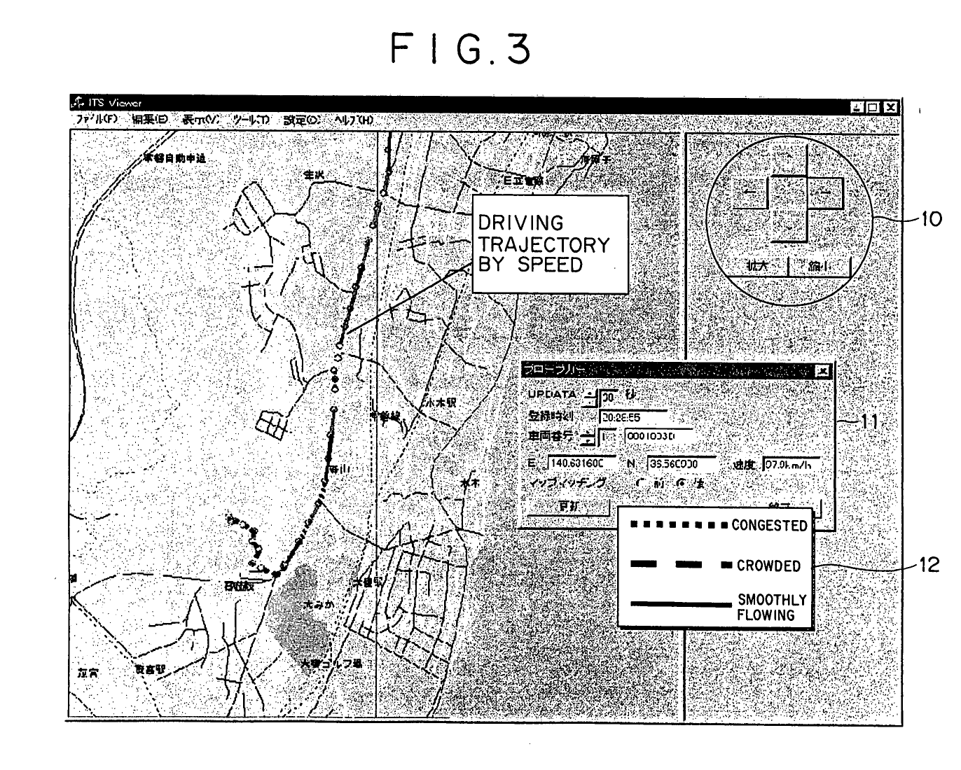

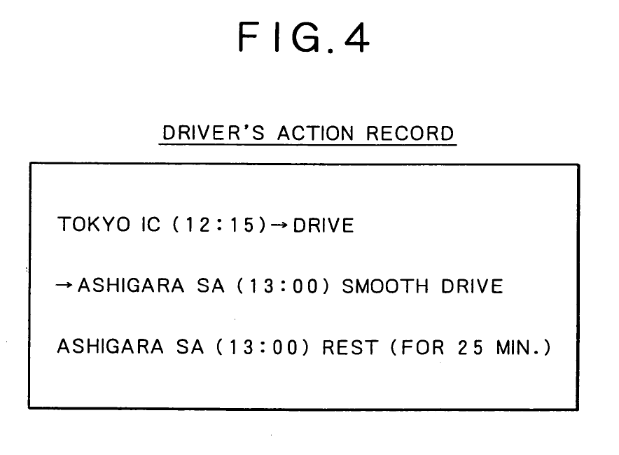

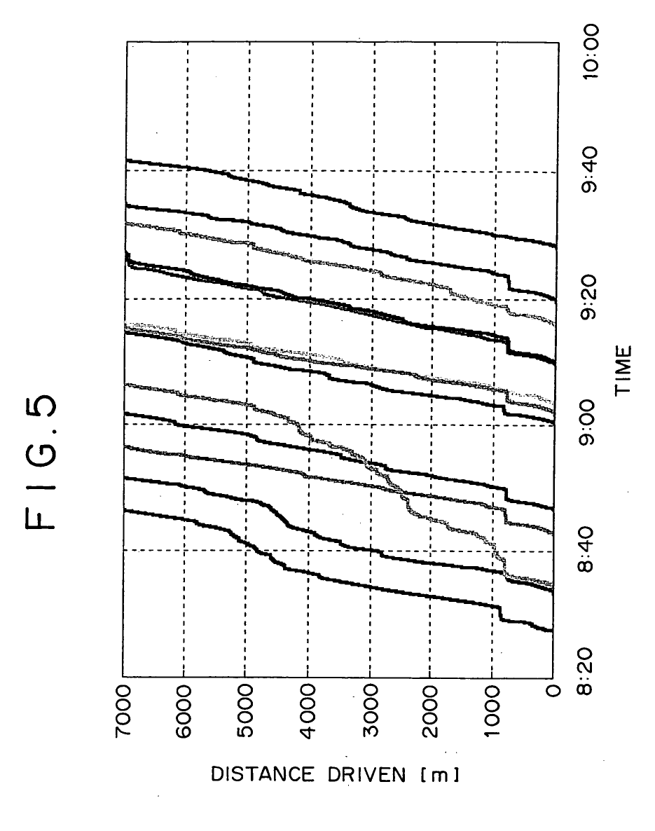

FIG. 3 shows a typical screen representing congestion information. It shows a trajectory through which vehicles are driven according to the speed on a traveling map. For ease of identification on a black-and-white drawing of the example figure, a solid line represents a smoothly flown traffic, a dashed line represents a crowded traffic, and a dotted line represents a congested traffic. Instead of using different types of lines, coloring may be used in actual applications. A portion marked with a reference numeral 10 in the FIG. is provided with arrows for scrolling the displayed portion on the map and an enlargement and reduction buttons. A reference numeral 11 represents a sub-screen entitled “Probe Car” and a reference numeral 12 is a legend. A still another sub-screen or an independent screen may be displayed to show a record of driver's actions as shown in FIG. 4 or statistical traffic information as shown in FIG. 5. The statistical traffic information shown in FIG. 5 may be produced as a hard copy as part of automatic generation of journals. In any event, it serves as a basis for predicting traffic along the schedule route through comparison between the statistical information and a trajectory of the local vehicle. It is preferable that the lines representing different types of data in FIG. 5 be colored for ease of identification.

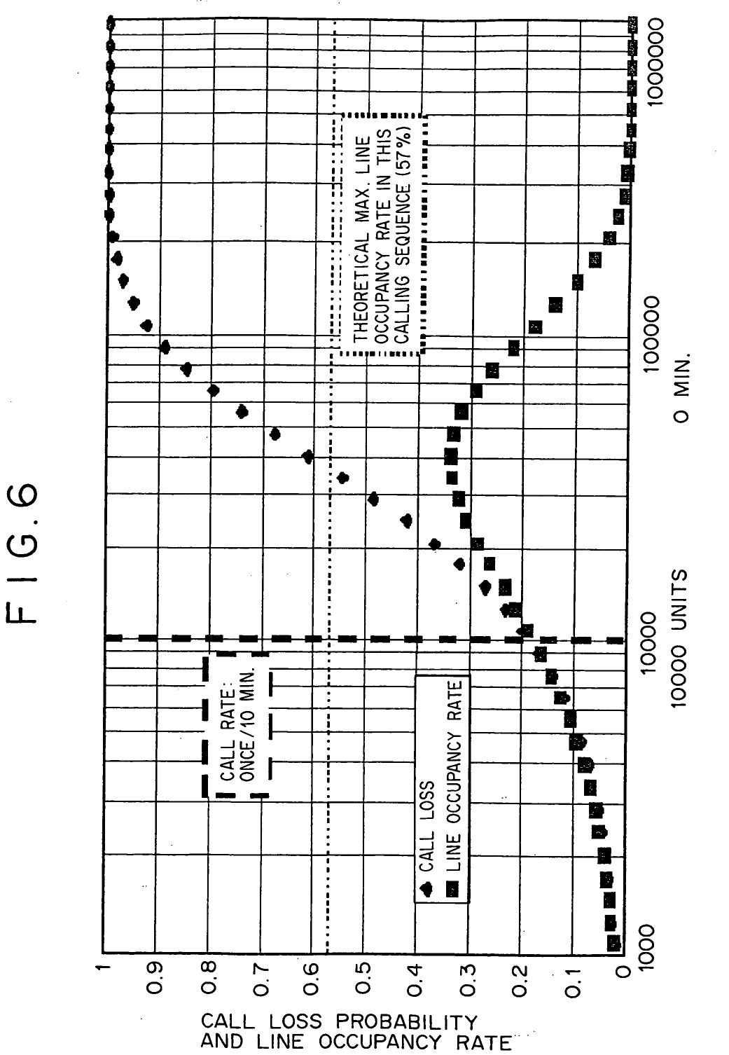

The result of simulation of call loss probability will be described referring to FIG. 6. The term “call loss probability” refers to a rate of failure in successful transmission of information (the call loss probability is 3% when there are three successfully completed calls out of 100 attempted calls). The data shows that the call loss probability is 0.2 (20%) which seems to be rather high; however, retrial greatly improves the probability of putting the call through. If the call loss probability is 0.2 and there are three retrials (that is, it is attempted to transmit a signal four times in total), the total call loss probability would be 0.2×0.2×0.2×0.2×0.2=0.0016, or a ratio of successfully completing calls would be 0.9984.

Suppose that the center 2 is a ground station provided with 100 channels. Unused channel information is transmitted to the satellite at 0.1-sec. intervals and received by contracted vehicles 4 as movable bodies (10,000 units). Each of the movable bodies is supposed to transmit a signal to the satellite by ALOHA method and the signal is received by the ground station 2. Additional assumptions are as follows: (1) the membership accounts for 10% of all vehicles present nationwide of about 50 million units, namely, five million units; (2) 20% of the five million units, or one million units, are operated on roads; (3) 200 bytes of information are gathered at every 10 min. from each of the vehicles; (4) lines are 2 kbps×10,000 lines (with a required bandwidth of 20 MHz according to the QPSK modulation system); (5) the downlink is used for broadcasting music, providing information for vehicles, and other purposes; however, the basic application is to transmit the same contents to all vehicles concerned and a band of 10 MHz is divided into several bands for each of different contents, and thus the downlink is excluded from the simulation; (6) the uplink will be further deliberated. Simulation is thus made on these assumptions and FIG. 6 shows a relationship among the number of calls made, call loss probability, and line occupancy rate per 10 min.

The ALOHA method refers to a method of transmitting information, in which a transmitting party transmits a signal whenever it wants to and, if a collision is encountered, the transmitting party retries. A method of transmitting information thereof is not controlled. (A form of Ethernet, in which retrial is attempted with a certain time lag if a collision is encountered, is one type of ALOHA method.)

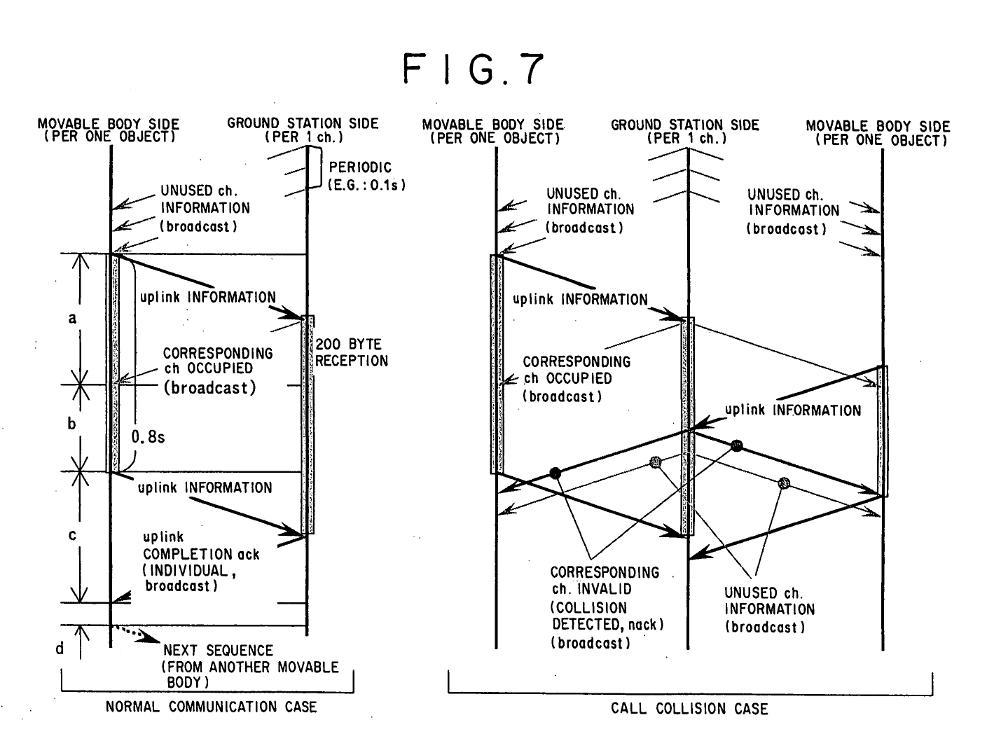

A typical timing chart that represents a transmission/reception relationship between a movable body and a ground station based on the simulation described in FIG. 6 is shown in FIG. 7. Referring to the figure, a reference symbol “a” represents a condition, in which authorization to use a channel is yet to be established, taking 0.5 sec., a reference symbol “b” represents a condition, in which authorization to use a channel is established, taking 0.3 sec., and a reference symbol “c” represents a condition, in which a communication end is being waited+an unused channel delivery completion is being waited, taking 0.5 sec. A reference symbol “d” represents a simulation time slice of 0.1 sec.

The point of 10,000 on the horizontal axis in FIG. 6 corresponds to a case, in which each movable body makes an uplink once in 10 min. in this model. The theoretical maximum line occupancy rate shown in the figure can be obtained using (a+b)/(a+b+c+d), since the entire sequence time is a+b+c+d (a, b, c, and d taking the values cited earlier), of which data communication time is a+b. This represents a ratio of time during which uplink data is being received to a channel operating time where a connection is smoothly and ideally established with each channel, that in this simulation being 57%. As the figure tells, the call loss probability is about 20% when a call is made once per 10 min. and, even if retrials to make up for call loss are included, it is fairly easily possible keep the call loss probability within 30%. It is expected that a call collision probability will be relatively small as the reduction ratio of the model approaches an actual system. Even in an intended case of mega-access made by one million users to 10,000 channels, therefore, communications are possible without filling the uplink bands. As is known from the foregoing discussion, the call loss probability can be held to a level of about 20% and, even considering bands for retrials, congestion can still be avoided.

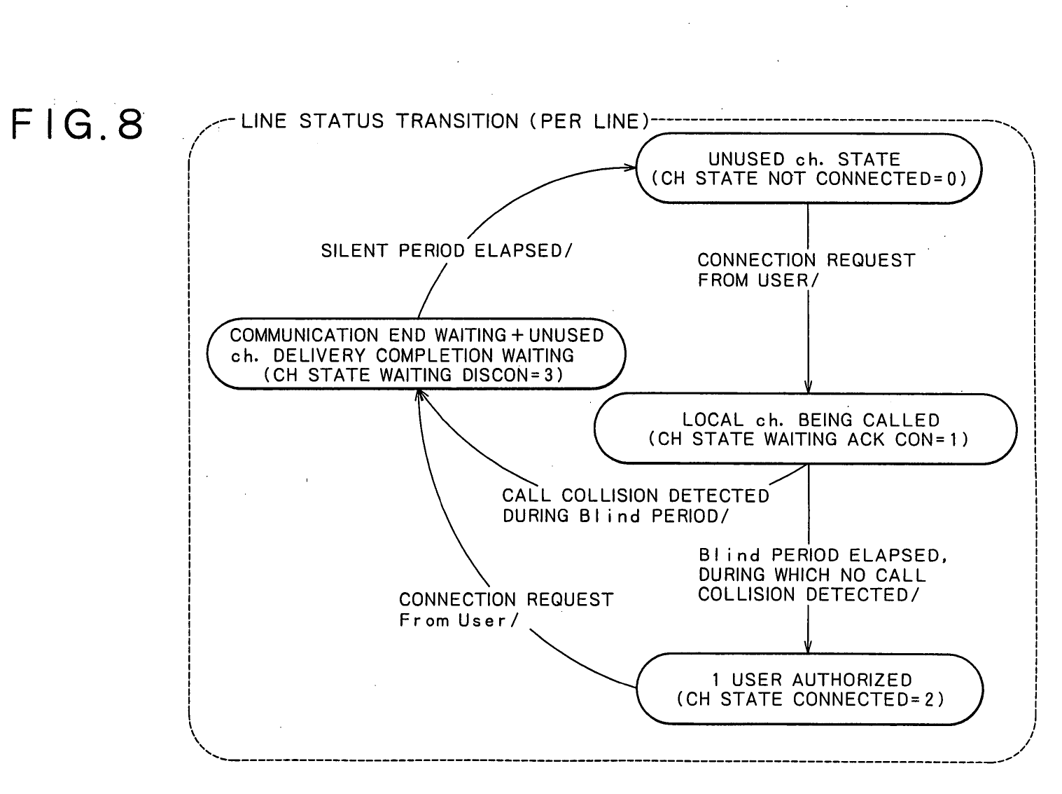

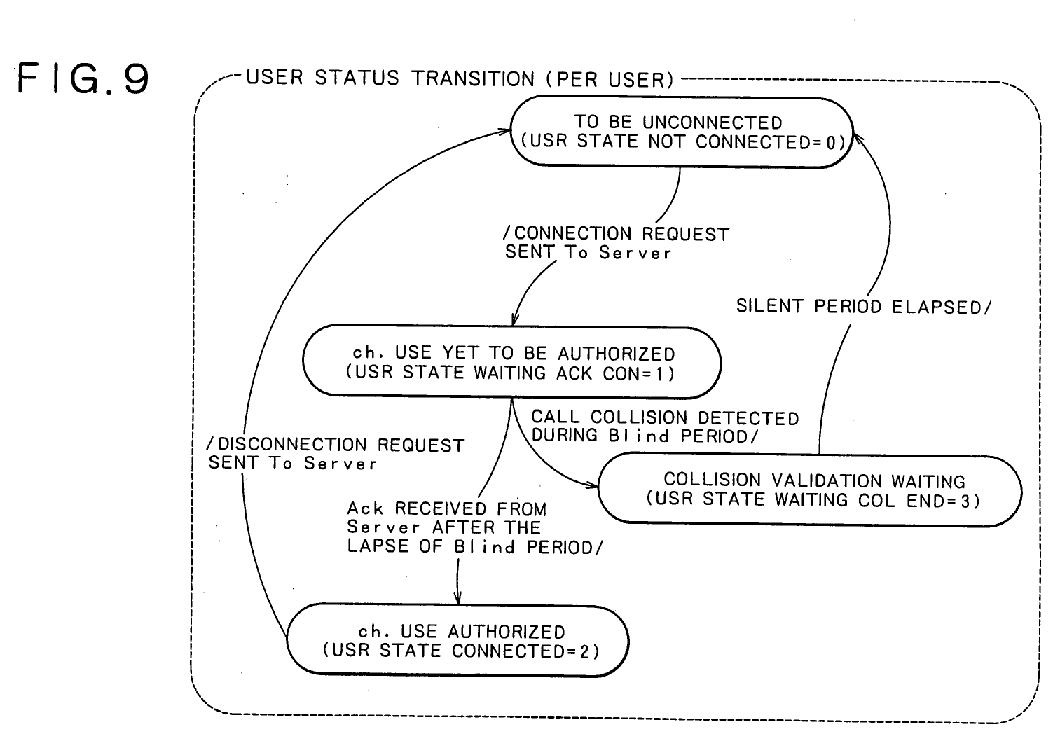

FIG. 8 shows status transition per channel on the ground station side and FIG. 9 shows status transition per one user on the movable body side.

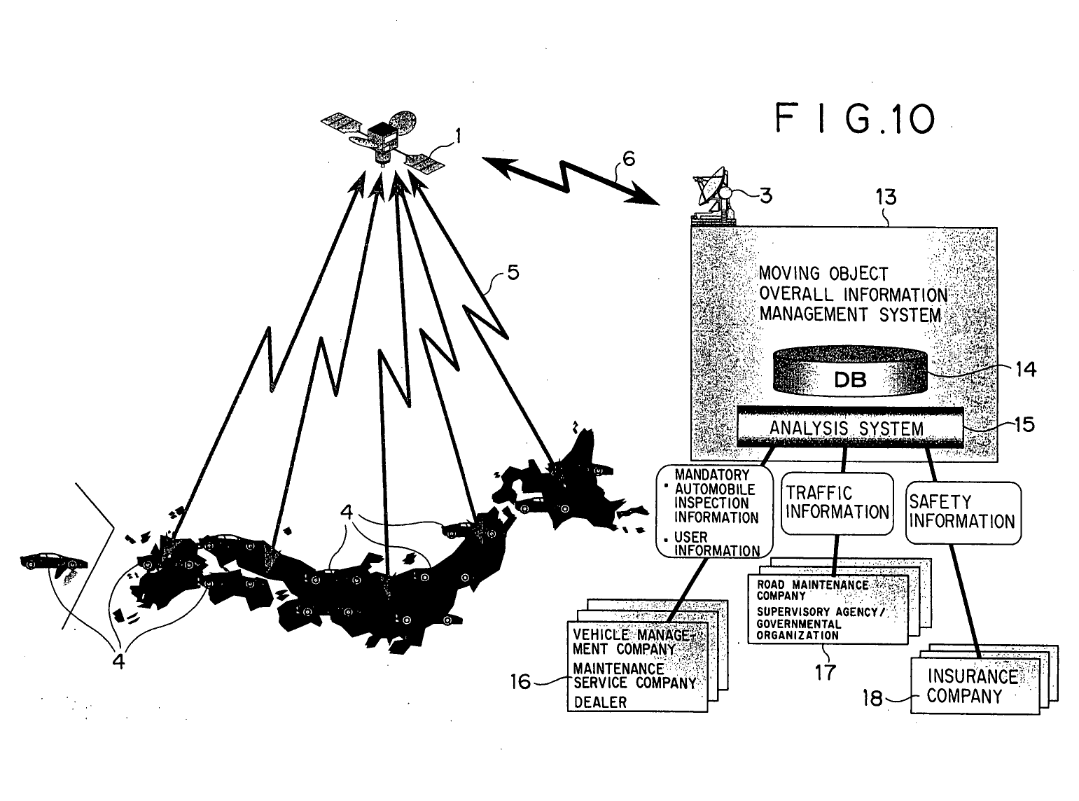

FIG. 10 is a conceptual diagram showing an overall information management system according to the invention covering the entire areas of Japan. Uplink information 5 that is transmitted via a satellite 1 to the center includes emergency information, such as accident and first aid information, engine/brake failure and other failure information, and predetermined interval information including a position, speed, direction, and condition (engine, electrical system, mechanical system) of the vehicle. Downlink information 6 transmitted from the center via the satellite 1 to each of the vehicles includes music information, image information, navigation information, road and traffic information, emergency information (callup), and new vehicle information. If the quasi-zenithal (for example: highly elliptic orbit) satellite system described in EP0880240A2 (hereinafter referred to simply as the highly elliptic orbit satellite) is used for the satellite, a comprehensive service network encompassing all areas of the nation can be achieved to provide services. A movable body overall information management system 13 serves as the core on the ground station side, provided with databases storing various types of data 14 and an analysis system 15. Through this analysis system 15, mandatory automobile inspection information and user information are distributed to an information requiring party 16, traffic information is distributed to another information requiring party 17, and safety information is distributed to a third information requiring party 18. The information requiring party 16 includes, for example, a vehicle management company, a maintenance and service company, and a vehicle dealer. The information requiring party 17 may be a road maintenance company, or a supervisory agency or governmental organization. The information requiring party 18 is, for example, an insurance company.

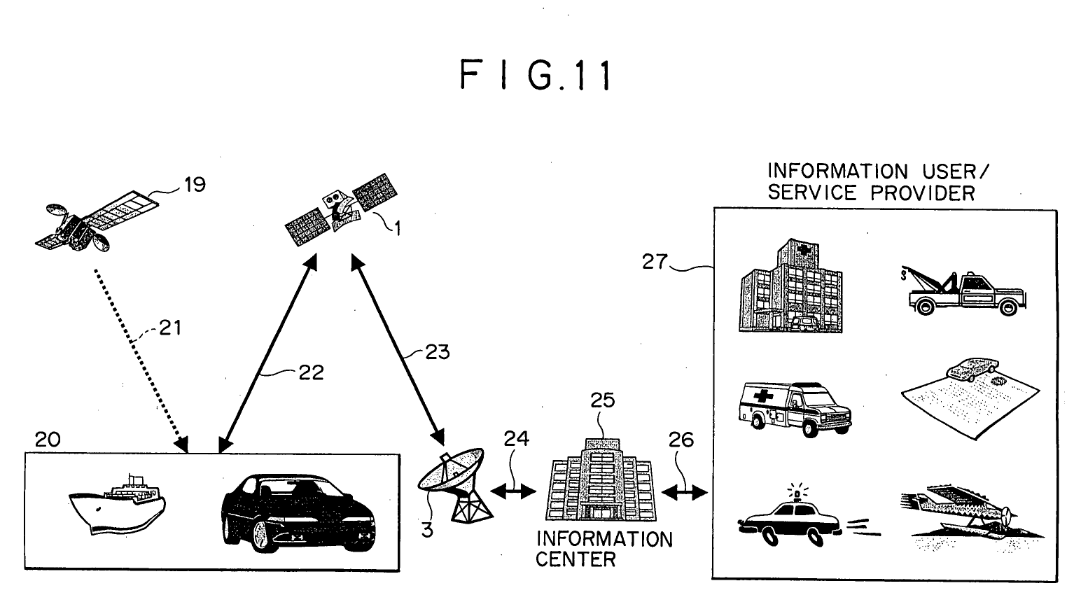

FIG. 11 shows a movable body overall information management system combined further with GPS. This embodiment does not, however, preclude a case in which the highly elliptic orbit satellite itself is provided with a GPS function. A GPS signal is transmitted from a GPS satellite 19 to each of movable bodies (ships and vehicles in the figure.) 20. An automatic information exchange 22 is carried out between each of the movable bodies 20 and an oblong satellite 1. These interactive communications are relayed by way of the satellite 1, a transmission/reception signal 23, antenna 3, a transmission/reception signal 24, an information center 25, and a transmission/reception signal 26 to an information user/service provider 27. Information of various kinds as it relates to a movable body 20 is automatically transmitted from the movable body 20 to the information center 25 which, based on the information received, automatically gives an advice to the service provider 27. Information is automatically transmitted from the movable body to the center when the movable body 20 becomes active, becomes stationary, and when an emergency (accident) occurs therein (in which a transmitter/receiver remains fully operational). This basically takes place at random. Two signal transmission and reception methods are available while the movable body 20 remains active (operating); namely, (1) the center 25 calls the movable body every 10 min., requesting transmission of information, and the movable body 20 transmits information to the center 25 in response to it; and (2) the movable body 20 transmits information to the center 25 every 10 min. Whichever method that is beneficial to line design is to be used.

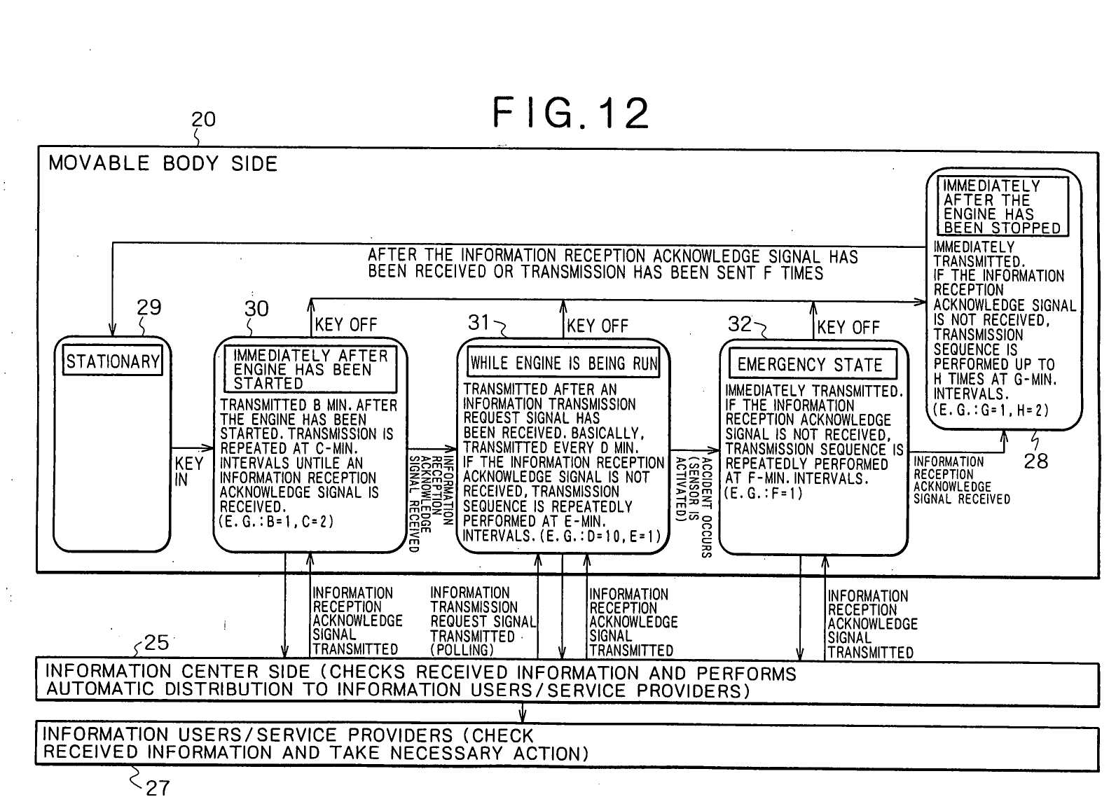

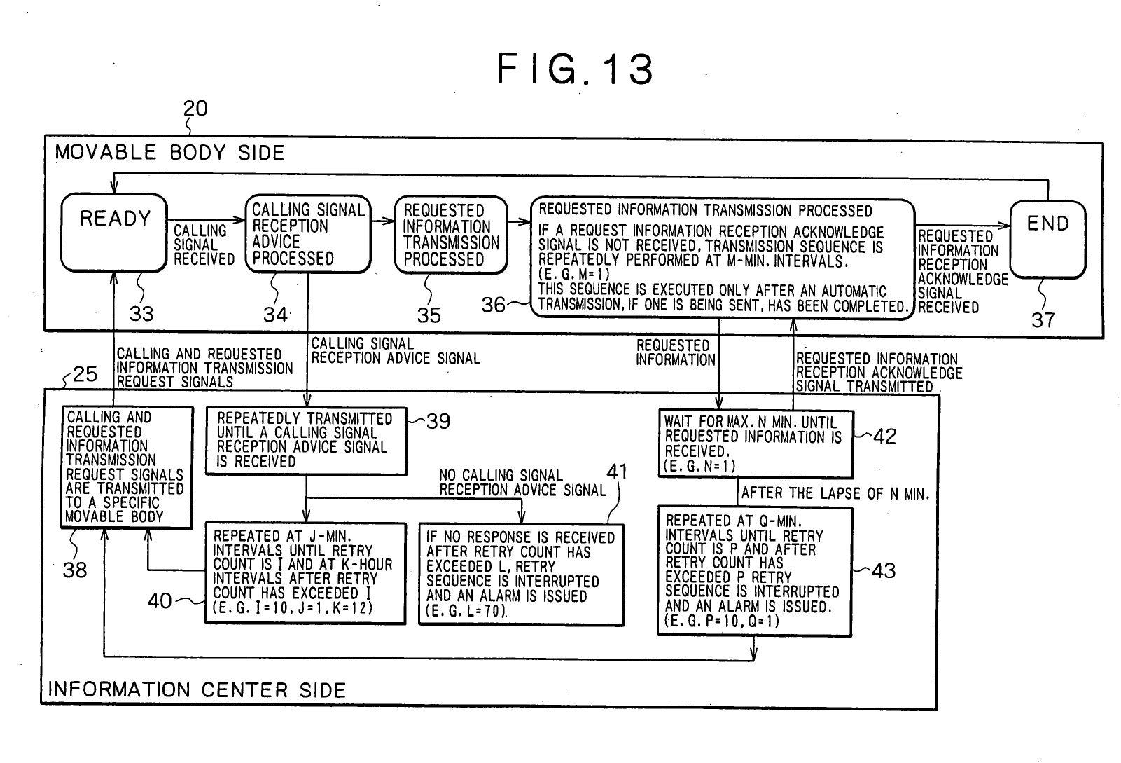

FIGS. 12 and 13 describe typical operations in interactive communications carried out using the system shown in FIG. 11. The discussion assumes the following: namely, the line specifications are 1 kHz (bandwidth), QPSK (transmission method), and 2 kbps (transmission rate); the maximum volume of data automatically transmitted and received is 200 bytes/unit.session (=1.6 kb/unit.session); 1 sec. is required for a single session (transmission of 200 bytes of data is completed in 0.8 sec. as calculated from the line speed); the maximum permissible number of sessions (line communications capacity per 1 min.) is 60 sessions/minute.line; and, the total number of lines is 10,000 and the theoretical number of sessions to be carried out is 600,000 times/min. based on 10 MHz allocated for the entire bands for sessions.

Immediately after the engine has been stopped 28, the moving body 20 sends a transmission of information without delay and, if an information reception acknowledge signal is not received, it performs a transmission sequence up to H times at G-min. intervals. For example, G=1 and H=2. After the information reception acknowledge signal has been received or a transmission has been sent F times, the movable body becomes stationary 29. The key is then inserted and a state is set immediately after engine has been started 30. B min. after the engine has been started, transmission is repeated at C-min. intervals until the information reception acknowledge signal is received. For example, B=1 and C=2. When the information reception acknowledge signal is received, a state is set in which the engine is operating 31. Information is then transmitted after an information transmission request signal is received; however, basically, information is transmitted every D min. If the information reception acknowledge signal is not received, transmission sequence is repeatedly performed at E-min. intervals. For example, D=10 and E=1. When an accident occurs, a sensor is activated and an emergency state 32 is established. In the emergency state 32, transmission is sent immediately and, if the information reception acknowledge signal is not received, transmission sequence is repeatedly performed at F-min. intervals. For example, F=1. When the information reception acknowledge signal is received, a state is set immediately after the engine has been stopped. A state immediately after the engine has been stopped 28 is set if the key is turned off in the state immediately after the engine has been started 30, the state in which the engine is operating 31, and the emergency state 32, respectively. Between the information center 25 and the movable body 20, there is carried out a transmission of the information reception acknowledge signal in the state immediately after the engine has been started 30, a transmission of the information transmission request signal (polling) and the information reception acknowledge signal in the state in which the engine is operating 31, and a transmission of the information reception acknowledge signal in the emergency state 32. The information center 25 checks the received information and performs automatic distribution to information users/service providers. Analysis information of various types is transmitted to the information users/service providers 27, intended for a specific party requiring the information and the received information is checked and necessary actions are taken accordingly.

When a calling signal is received by the movable body 20 in a ready state 33, calling signal reception advice processing 34 is performed, which is followed by requested information collection processing 35 and then requested information transmission processing 36. In requested information transmission processing 36, if a requested information reception acknowledge signal is not received, transmission sequence is repeatedly performed at M-min. intervals, except that the sequence is executed only after an automatic transmission, if one is being sent, has been completed. For example, M=1. The sequence is terminated 37 when the requested information reception acknowledge signal is received and then the movable body returns to the ready state 33. On the side of the information center 25, a calling signal reception advice signal, as a result of the calling signal reception advice processing 34 performed on the movable body 20 side, is received in step 39. In this step 39, transmission is repeated until the calling signal reception advice signal is received before the operation proceeds to step 40 or 41. In step 40, transmission is repeated at J-min. intervals until retry count is I and at K-hour intervals after retry count has exceeded I. For example, I=10, J=1, and K=12. If there is no calling signal reception advice signal in step 39, the operation proceeds to step 41, in which, if no response is received after retry count has exceeded L, retry sequence is interrupted and an alarm is issued. For example, L=70. In this step 41, contact with the corresponding movable body 20 is disabled. If the operation proceeds through step 40, it then proceeds to step 38, in which a calling and requested information transmission request signals are transmitted to step 33 on the movable body 20 side. In step 38, the calling signal and requested information transmission request signal are transmitted to a specific movable body in response to a request made by the information user/service provider. Requested information is transmitted from step 36 on the movable body side to step 42 on the information center 25 side, while a requested information reception acknowledge signal is transmitted from step 42 to step 36. In step 42, the information center is in a wait state for a maximum of N min. until requested information is received. For example, N=1. The operation proceeds to step 43 after the lapse of N min. and then to step 38. In step 43, transmission is repeated at Q-min. intervals until retry count is P and the retry sequence is interrupted and an alarm is issued when the retry count exceeds P. For example, P=10 and Q=1.

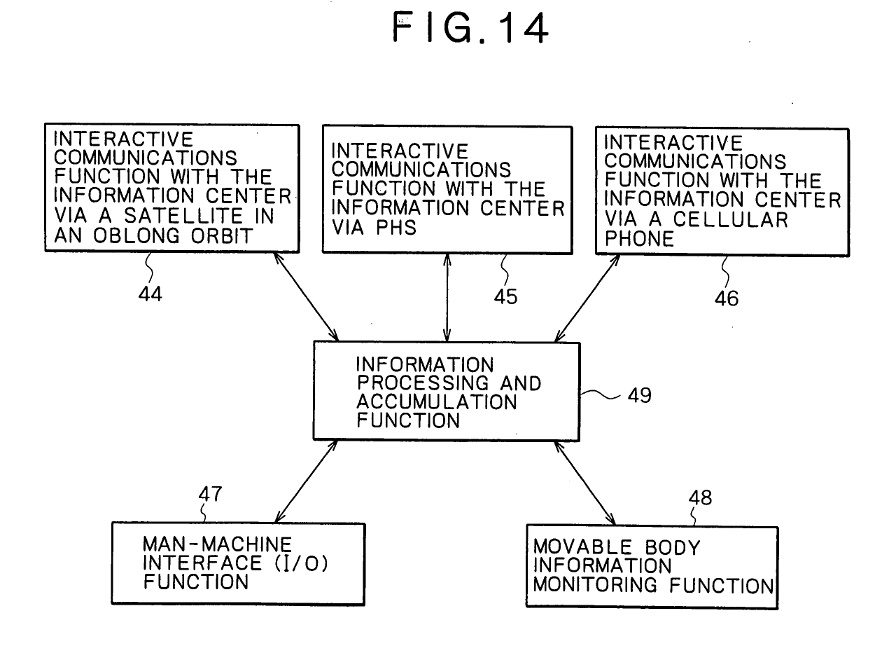

FIG. 14 shows the basic functions provided for a transmission/reception terminal on the movable body side. That is, an interactive communications function with the information center via the oblong satellite 44, an interactive communications function with the information center via PHS 45, an interactive communications function with the information center via a cellular phone 46, a man-machine interface (I/O) function 47, and a movable body information monitoring function 48 are, respectively, interrelated with an information processing and accumulation function 49.

Table 1 lists the types of transmission information.

TABLE 1

| | Type of | Contents of | Use of | Typical Businesses |
|---|---|---|---|---|
| No. | Information | Information | Information | Using the Information |
| 1 | ID No. | IP address | To specify the | |
| | | | transmitting party | |
| 2 | Transmission | Time-of-day | | |
| | time | and date of | | |
| | | transmission | | |
| 3 | Position when | Position | Tracking of a stolen | Expanding theft insurance |
| | transmission | information | car, probe car, | business (reduced |
| | is sent | obtained | identifying mutual | insurance premium rate → |
| | | through GPS | positions among | increased number of |
| | | | companion movable | policyholders) |
| | | | bodies, traveling | Enhancing information |
| | | | route information | service for automobiles |
| | | | | (collecting more accurate |
| | | | | traffic information and |
| | | | | congestion information, |
| | | | | enhancing navigation |
| | | | | functions, etc. |
| 4 | Movable body | Information on | Remote monitoring | Remote monitoring and |
| | equipment | equipment and devices | (predicting life | maintenance business for |
| | | that are effective for | expectancy and fault | movable bodies, |
| | | quickly isolating | occurrence), quick | expanding automobile |
| | | faults and maintenance | maintenance service | company's maintenance |
| | | services (mileage, | when a fault occurs | business (enhanced |
| | | coolant temperature, | [including remote | service quality → |
| | | coolant level, engine | maintenance (action | gaining more customers), |
| | | oil, brake oil, etc.) | advice)], identifying | revising premium rate by |
| | | | driving habits | insurance companies |
| | | | | (differentiation from |
| | | | | competitors) |
| 5 | Movable body | Information relating | | |
| | operations | to operations and | | |
| | | driving (driving | | |
| | | speed, acceleration/ | | |
| | | deceleration timing, | | |
| | | engine speed, etc.) | | |
| 6 | Accident | Sensor signal | Passing accident | Security businesses |
| | | detecting the | information at early | [police station, fire |
| | | occurrence of an | stages | department (ambulance), |
| | | accident [seat belt/ | To quickly take | hospital], automobile |
| | | air bag activation | repairing actions for | companies and maintenance |
| | | information, | the damaged vehicle | companies, enhancing |
| | | acceleration sensor | To quickly rescue | information service for |
| | | (impact detection | injured persons | automobiles (early |
| | | sensor), etc.] | (calling an ambulance | prediction of expected |
| | | | and the police at | traffic congestion), |
| | | | early stages) | insurance companies |

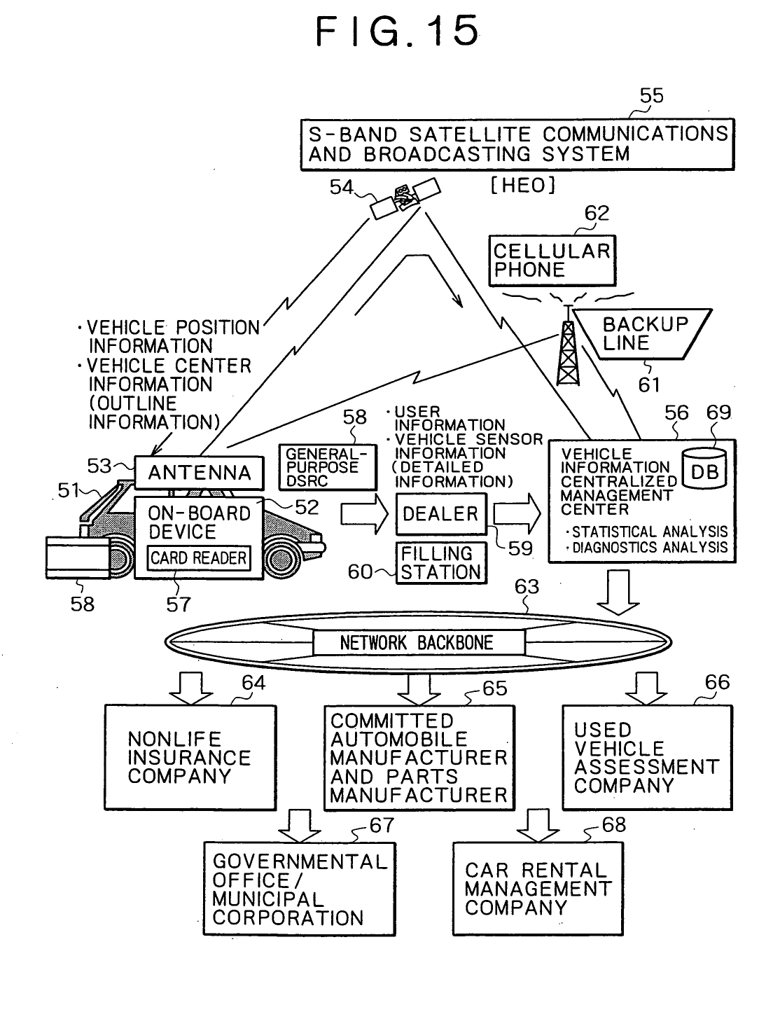

FIG. 15 is a conceptual diagram showing a typical system embodying the invention. Referring to the figure, vehicle condition information provided by a vehicle 51 may be classified into two groups, of which vehicle position information is transmitted to an artificial satellite 54 via an on-board device 52 mounted in the vehicle 51, on which various types of controlling devices are mounted, and an antenna 53. The vehicle position information may include longitude and latitude data provided by a navigation terminal. In terms of the scope of this invention, it is perfectly natural that the contract assumes distribution of music and/or image information and therefore the details in this regard will be omitted in the description of the embodiments to follow.

A signal reflected off the artificial satellite 54 (the satellite is preferably a non-geostationary satellite in an elliptic orbit, classified into a quasi-zenithal satellite) is transmitted as vehicle information to a centralized management center through, for example, an S-band satellite communications and broadcasting system (as an example of the quasi-zenithal satellite, a highly elliptic orbit satellite system, which is hereinafter referred to as HEO) 55.

Each vehicle is provided with various sensors that detect vehicle operating conditions for providing vehicle sensor information. Before the vehicle sensor information is transmitted, it is possible to transmit and program in advance vehicle body information used to determine a specific vehicle model, including, for example, a vehicle model, body serial number, date of manufacture, and the name of a prefecture in which the vehicle is registered, and user information. The vehicle is also provided with a card reader/writer 57, with which a card for the exclusive use by the user 58, for example, a credit card for payment of toll charges, is to be used. This user card 58 is recorded with user information which includes, for example, the user name, date when the driver's license was obtained, number of years of driving experience, and a bank account number. The card can also be used for paying insurance premiums of a vehicle insurance to be described later.

Vehicle body information and part of the vehicle sensor information are transmitted, as outline information, to the artificial satellite 54 via the on-board device 52 and the antenna 53. It is gathered at the centralized information center by the S-band satellite communications and broadcasting system 55 in the same manner as the vehicle position information.

The rest of the vehicle information is input and collected by, for example, a general-purpose DSRC (or dedicated short range communication) 58, through a dealer or directly to the centralized management center. The rest of the vehicle information includes user information, detailed information as part of vehicle sensor information, and vehicle body information. Data of gasoline purchased using the card 58 may be input and collected via a gas station in the same manner at the centralized information center 56 as electronic information. This provides fuel economy and engine information. Vehicle information of other types is input and collected at the centralized management center 56 through a radio communications means as a backup line 61.

The vehicle information collected at the centralized management center 56 is analyzed for use in statistical analysis and diagnostics analysis. The vehicle information used in statistical analysis and diagnostics analysis is recorded in a computer database (DB) 69 and, at the same time, provided for a nonlife insurance company 64, committed automobile manufacturer and parts manufacturer 65, used vehicle assessment company 66, governmental office/municipal corporation 67, and a car rental management company 68 through a network backbone, namely, a public phone line and the Internet. It goes without saying that these pieces of information are provided under restricted conditions, such as through contracts, not given with any limitations or principles. Providing vehicle information from each vehicle also abides by certain restrictions, such as contracts; it is not done with any limitations or principles, either. A benefit of some sort may be granted to a user who accepts to provide information.

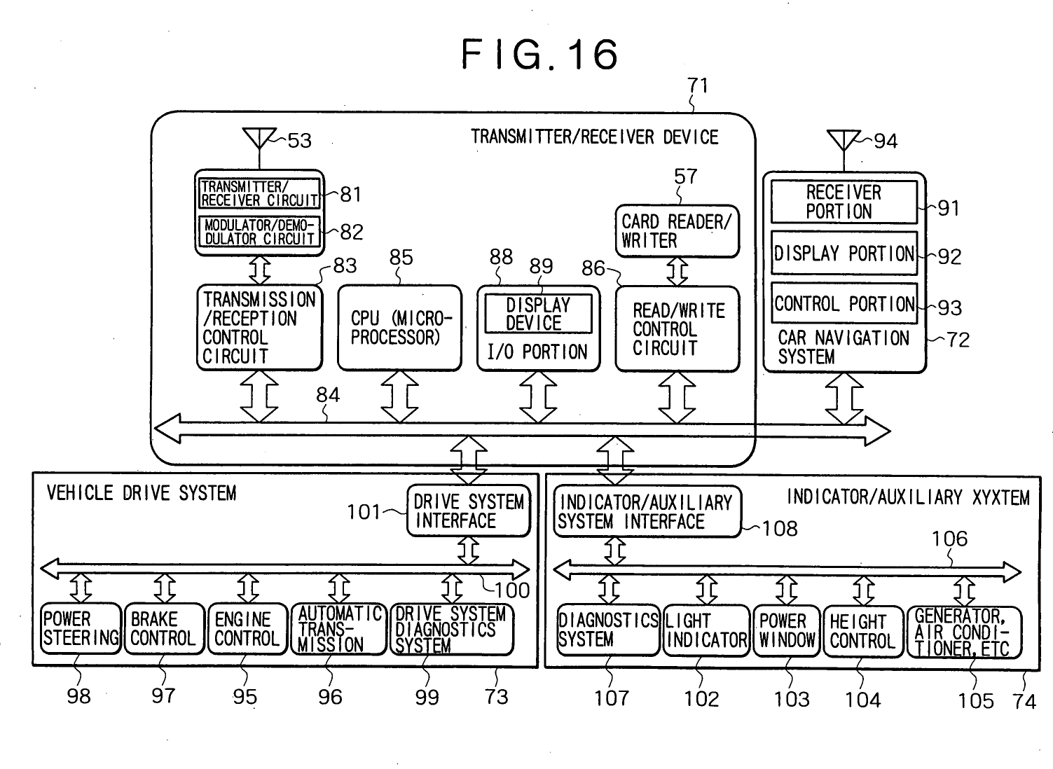

FIG. 16 shows an on-board device. Referring to the figure, the on-board device comprises a transmitter/receiver device 71, a car navigation system 72, a vehicle drive system 73, and an indicator/auxiliaries system 74.

A signal from the antenna 53 is received through a transmitter/receiver circuit 81 and a modulator/demodulator circuit 82, demodulated by the modulator/demodulator circuit 82, decoded by a transmission/reception control circuit 83, and read in a CPU 85 through a bus 84.

The CPU 85 gets the transmission/reception control circuit 83 to encode the information to be transmitted, the modulator/demodulator circuit 82 to modulate it, and the transmission/reception control circuit 83 to send it through the antenna 53.

A card is read by a card reader/writer 57 and the data is read by the CPU 85 through a read/write control circuit 86. The data to be written in the card is, on the other hand, sent by the CPU 85 to the read/write control circuit 86 which, in turn, writes the data through the card reader/writer 57.

The user operates an I/O portion 88 to tell the CPU 85 what to do. The CPU 85 gives necessary information on a display device 89 of the I/O portion 88, or provides voice information through a means not shown.

The navigation system 72 is provided with a receiver portion 91, a display portion 92, a control portion 93, and an antenna 94. It has a record of a current position, route through which the vehicle has traveled, and map (road and traffic information) information, capable of providing required information for the CPU 85 upon receiving a request made therefrom.

A portion enclosed by a rectangle representing the transmitter/receiver device 71, which comprises the antenna 53, transmitter/receiver circuit 81 and modulator/demodulator circuit 82, transmission/reception control circuit 83, CPU 85, I/O portion 88, card reader/writer 57, and the read/write control circuit 86, is the system used in the embodiment of the invention. It is further connected to other devices and systems to obtain required information.

These devices and systems are as follows.

The vehicle drive system 73 comprises an engine control device 95, automatic transmission device 96, brake control device 97 (anti-skid control), power steering device 98, and a drive system diagnostics system 99 for making a diagnosis of these devices every moment, each being connected to each other through an internal bus 100. The drive system diagnostics system 99 determines whether or not the value of an internal sensor in each of the devices falls within a specified range and a voltage and current fall within a specified range and stores the readings at predetermined intervals and whenever a faulty value is detected. The stored data is read by the CPU 85 through a drive system interface 101.

The indicator/auxiliaries system 74 comprises a light indicator control device 102 that controls headlamps and turn signal lamps and indicates operations of a brake and other vehicle devices, a power window control device 103, a height control device 104 that adjusts vehicle height and vehicle dampers, a generator, an air conditioner 105, and other devices. Each of these devices is connected to each other through an internal bus 106. An indicator/auxiliaries system diagnostics system 107 diagnoses whether each of these devices is operating normally and whether any is operated and retains fault and operation data. The CPU 85 can read the retained data through an indicator/auxiliaries system interface 108 as necessary.

When a transmission of diagnosis results information is sent from the diagnostics systems 100, 107, the CPU 85 determines whether it is necessary to transmit the information to the artificial satellite and, when it determines it is necessary to do that, directs the transmission/reception control circuit 83 to transmit the diagnosis results. The transmission/reception control circuit 83 is provided with a channel with which a permission to transmit is requested to the artificial satellite which, in turn, allocates a transmission channel for the transmission/reception control circuit. The transmission/reception control circuit uses this channel to send a transmission to the artificial satellite. Prior to transmission of the diagnosis results, the CPU 85 can cause the data to be input in the centralized management center 56 by giving the transmission/reception control circuit 83 the model of the vehicle, vehicle or user name, and other data and transmitting the data to the artificial satellite. It is also possible that the CPU 85 performs the same function to input sensor information in the centralized management center 56 upon receipt of a transmission of on-board sensor information, without using the intervention of the diagnostics systems 100, 107, thereby making a diagnosis based on collected information. Vehicle information can also be collected using this method.

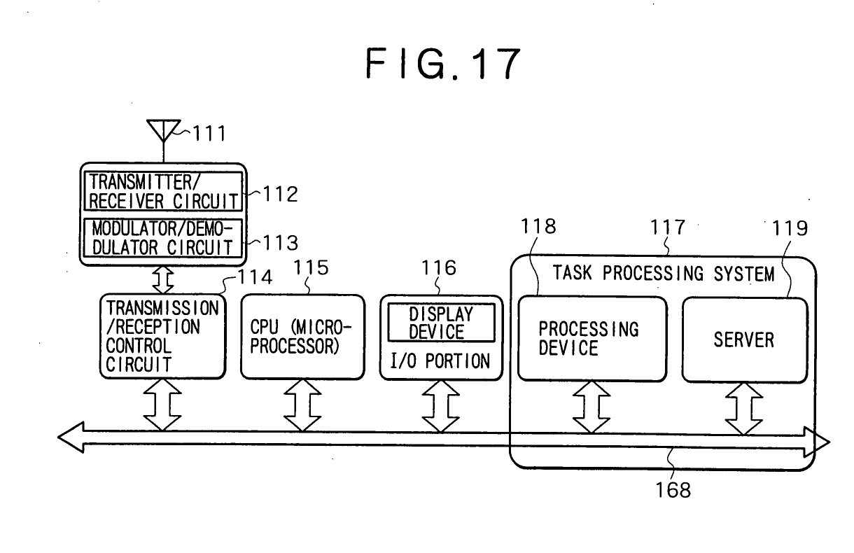

FIG. 17 shows the system on the side of a centralized management center that receives information from vehicles. An antenna 111, transmitter/receiver circuit 112, modulator/demodulator circuit 113, transmission/reception control circuit 114, CPU 115, and an I/O portion 116 have the same functions as those components cited earlier. In addition to the CPU 115, there is provided a task processing system 117 that is provided with a computer or a processing device 118, retaining a large volume of data. The processing device is connected via a bus 168 to a server 119. The task processing system 117 organizes data according to the vehicle model, user, and serial number and stores it in the server. It unloads data from the server 119 to provide information as necessary.

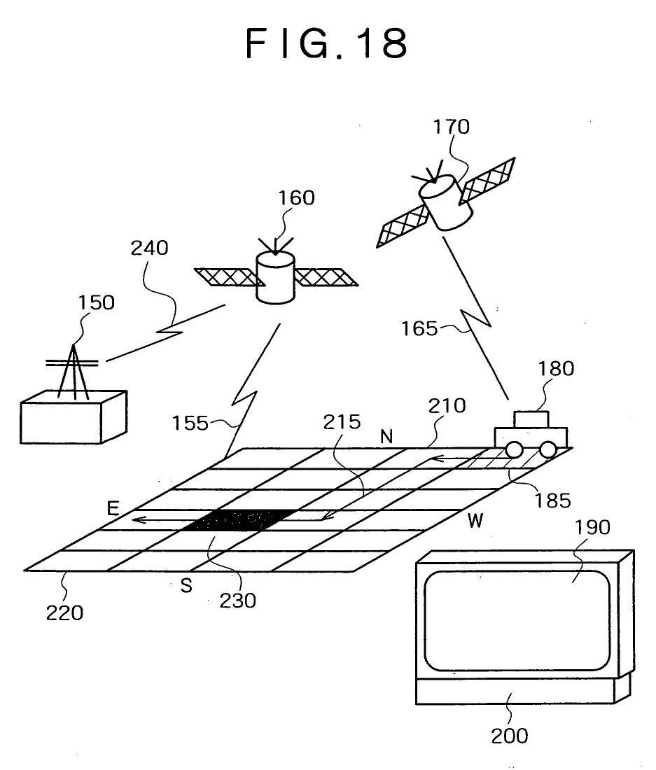

FIG. 18 shows an outline of a satellite communications and broadcasting system. Referring to the figure, a reference numeral 150 represents a broadcast station, a reference numeral 160 represents an artificial satellite for broadcast (54 in FIG. 15), a reference numeral 170 represents a GPS satellite, a reference numeral 180 represents a vehicle, a reference numeral 200 represents a car navigation system, and a reference numeral 190 represents an information display on the car navigation system 200. The car navigation system 200 is provided with a receiver device. It is also mounted in the vehicle 180, serving as an on-board device for detecting positions, searching for routes, and giving information display.

In addition, a reference numeral 240 represents a satellite broadcast transmission signal from the broadcast station 150, a reference numeral 155 represents a satellite broadcast signal from the artificial satellite for broadcast 160, a reference numeral 165 represents a signal for position confirmation from the GPS satellite 170, a reference numeral 220 represents an entire range of areas subject to information transmission, a reference numeral 185 represents a traveling route through which the vehicle 180 moves, a reference numeral 210 represents an area corresponding to the traveling route 185 of the vehicle 180 on the entire range of areas 220, a reference numeral 230 represents an area subject to information transmission on the entire range of areas 220, and a reference numeral 185 represents an area in which the vehicle 180 is currently present on the entire range of areas 220.

The entire range of areas subject to information transmission 220 is broken down into small areas as shown in FIG. 15. The broadcast station 150 and the car navigation system 200 are to have the same information concerning this division into small areas. The car navigation system 200 is to be capable of identifying the position of the vehicle 180, receiving the satellite broadcast signal 155, and providing information.

The broadcast station 150 sets the area 230 for the area subject to information transmission and transmits information, with information identifying the area 230 appended thereto, by means of the satellite broadcast transmission signal 240 to the artificial satellite 160. The artificial satellite 160 for broadcast, which receives the satellite broadcast transmission signal 240, transfers it in the form of the satellite broadcast signal 155.

Having received the signal for position confirmation 165 from the GPS satellite 170, the car navigation system 200, on the other hand, has identified the position of the vehicle 180. The car navigation system 200 has also identified the area 175 in which the vehicle 180 is present on the entire range of areas 220. Moreover, the car navigation system 200 has identified the corresponding area 210 based on the retained data previously input by the driver or the traveling route 185 found through a route search function thereof.

Receiving broadcast, the car navigation system 200 receives the satellite broadcast signal 155 and reads information contained therein and one that identifies the area. At this time, it reads the information that identifies the area 230. The car navigation system 200 can find the area 175 in which the vehicle 180 is present, the traveling route 185, and a point to which the vehicle moves.

The artificial satellite for broadcast 160 shall be one that is located in the zenith direction at all times when viewed from the ground and reception sensitivity of the car navigation system 200 may be focused on to receive signals only from the artificial satellite. This reduces radio disturbances caused by buildings and other structures, thus realizing a broadcasting system having no interruption of broadcast and providing information in accordance with the conditions of each movable body.

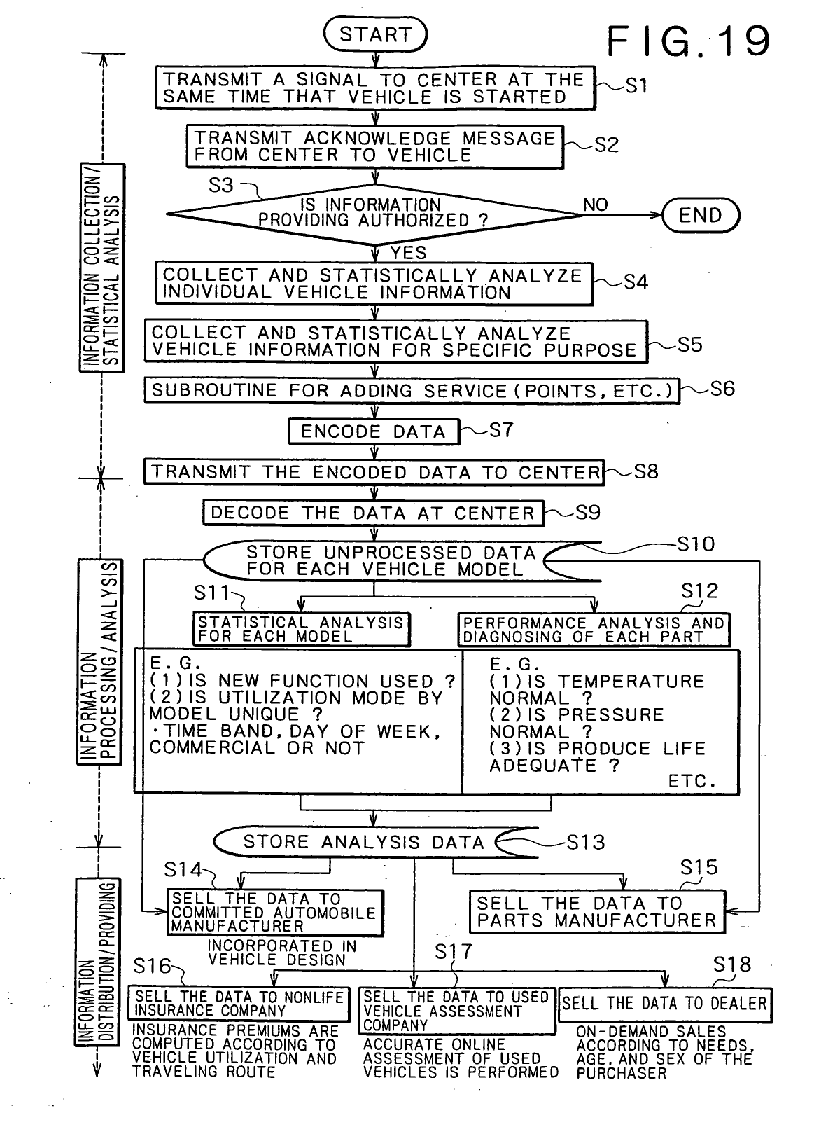

FIG. 19 is a flow chart showing collection, analysis, and processing method of vehicle condition information. Referring to the figure, (1) immediately after the driver or user has inserted the key and started the engine, a start signal is automatically transmitted from the vehicle to the centralized management center (S1). The HEO path, which is considered to have the lowest communications failure rate, is mainly used for the communications method, while the use of DSRC or cellular phones is to be permitted.

(2) Then, the center, having received the foregoing signal, transmits an acknowledge message for authorizing providing of information to the vehicle (S2).

(3) A confirmation is made with the driver whether or not to authorize providing of information (S3). A method of giving the confirmation is either voice or display. Response is to be given using two or more buttons on the on-board device.

(4) Only when it is authorized to provide information, individual vehicle information concerning each individual vehicle is collected and statistically analyzed (S4). Based on the data, vehicle information for a specific purpose, for example, classified according to insurance company, is collected and statistically analyzed (S5).

(5) Only when it is authorized to provide information, a system is started that adds up service points (S6). The service points is to be designed to increase in proportion to the mileage and the period of time through which the engine is running, providing a system whereby the more the vehicle is driven, the more the user is entitled to receive service benefits. Service points are to be managed according to not only the vehicle, but also the user. To accomplish this, an ID card issued for each individual user is to be inserted into the on-board device, which automatically transmits such information as the age, sex, blood type, and other information.

(6) The vehicle condition information, as the term is used in the foregoing, refers to the following and the level of disclosure may be selectable even when it is authorized to provide information. <1> Vehicle position information: longitude and latitude information obtained through the navigation terminal; <2> vehicle control information: brake operating amount, steering angle, accelerator opening, gear ratio, ABS activation time, VSC (skid control mechanism) activation time; <3> vehicle parts condition information: oil temperature, oil pressure, voltage, fuel level, CPU condition, muffler temperature.

(7) Data is encoded (S7) and transmitted to the center (S8). Steps up to this point represent the information collection function. Information processing and analysis functions will next be described. (8) The data is decoded at the center (S9), and (9) unprocessed data for each vehicle model is stored in the database.

(10) Data is statistically analyzed for each model (S10, S11). That is, <1> how frequent a new function mounted to differentiate from competitors is used, and <2> if utilization mode by model is unique, in terms, for example, of time band, day of week, and application, whether it is for commercial use or not.

(11) A performance analysis is made of each part (S10, S12). That is, <1> if temperature is abnormal, <2> if pressure is abnormal, and <3> if a product life is appropriate. (12) The analyzed data is then stored in the database (S13).

The data providing service for committed automobile manufacturers and parts manufacturers will then be described. This is concerned with a service to provide committed automobile manufacturers and parts manufacturers with the data stored through the information collection, processing, and analysis functions described in the foregoing flow chart. <1> Data is sold and provided through a network in response to a request for purchasing it made from a committed automobile manufacturer or parts manufacturer (S14, S15). The network is a public switched network and the applicable means can be selected according to the customer needs. <2> Data is encoded before transmission for fear of monitoring by other companies. <3> The manufacturer which receives the data may be able to use it in the following ways.

Applications of the statistical analysis data will be described. <1> The statistical analysis information, which tells a specific model used by a specific generation in a specific time band on a specific day of the week, is analyzed to deliberate on functions the model lacks in, those overly provided, and pricing. <2> It is determined how frequent a new function mounted to differentiate from competitors is used and, if it is found that the function is fairly frequently used, application to other models is examined; if it is found that the function is not very often used, then standard equipment and pricing are reviewed and possibility is examined whether or not to even abandon it. <3> A presentation is made to the dealer about the fast-selling vehicle models and functions according to age and sex, promoting sales effort classified by the generation and sex of customers.

Applications of the performance analysis data by the part will be described. <1> Identifying failure frequency for each part will provide good evidence for attesting validity of product life. <2> When advice of an abnormal condition is received from a user (driver), unprocessed information before and after the failure and performance analysis data are provided in a package for the repair company and dealer, thereby helping them identify a cause or causes of the abnormal condition that is not reproduced easily.

The data providing service for used car-related businesses will be explained. This is concerned with a service to provide used car sales agents and dealers with the data stored through the information collection, processing, and analysis functions of system example 1 (S18). <1> A vehicle purchaser connects to the center in an effort to find the assessed value of his/her own car. <2> The center examines in details information used to determine internal conditions of various pieces of vehicle equipment (e.g., engine control information, steering wheel angular velocity, ABS cumulative activation time, and VSC cumulative activation time) and information on driving routes harmful to the vehicle (seashore, snow-covered roads: both contributing to salt damage), in addition to the inspection record of the vehicle for which an assessment is requested, mileage, and model and type, thereby calculating and determining an assessment value. <3> The foregoing method allows the service to be provided also for dealers, used car sales agents, wreckers, and automobile repair shops in which trade-in vehicles are likely to be driven in.

The data providing service for the Environment Agency will be described. This is concerned with a service to provide the Environment Agency with environment-related information of all the data stored through the information collection, processing, and analysis functions described in the foregoing flow chart. <1> Hazardous gases contained in the exhaust emissions from the engine are sampled at random and checked to see if the environmental standard values are met. <2> A statistical analysis is made for each vehicle model and, if the predetermined number of vehicles fall short of the standard value in a specific model, the Environment Agency makes an improvement recommendation for the model.

The data providing service for car rental companies and rental car users will be described. This is concerned with a service to provide car rental companies with position information of all the data stored through the information collection, processing, and analysis functions described in the foregoing flowchart.

For car rental companies: <1> When a rental validity expires of a rental car or a car used for community transport, the car automatically transmits its position data to the center via HEO. <2> The center sends a transmission to the rental car management company to enable the management company to start monitoring the rental car whose validity has been expired. Possible methods of providing the information are a) longitude and latitude information; b) place name information; and, c) map showing graphic screen information. “Community transport” as the term is used in the above context means an urban rental car system that allows a number of rental cars to be shared among a specific community and any to be left unattended after use.

For rental car users: <1> Though corresponding to a different category under the current division, this service transmits commercial information applicable to a specific area to users. <2> A commercial provider is tied up with a car rental company and, if a user accepts to receive commercial information, part of the rental fees will be returned in cash. <3> Possible media are the navigation monitor and only through audio.

The data providing service for municipal corporation electronic road pricing will be described. This is concerned with a service to provide a municipal corporation with information as it relates to a predetermined restricted zone (e.g., municipal boundary), whether the vehicle has moved therethrough, time of entry therein, and a cumulative time of driving therethrough, of all the data stored through the information collection, processing, and analysis functions described in the foregoing flowchart. <1> To a vehicle approaching the restricted zone, an automatic transmission is sent from the center via HEO (oblong satellite; the same abbreviation is hereinafter used) and the HEO informs the vehicle that “you are approaching the restricted zone” and that “you will be charged for a sum per a predetermined period of time if you drive through it.” Available methods to determine that a vehicle enters the restricted zone are by means of position information as found through the on-board GPS function and through a DSRC on the road side without using HEO. <2> After the advice given in step <1>, the on-board device is used to constantly monitor whether the vehicle has moved past the restricted zone and, when the vehicle does move past the restricted zone, information on the entry time, days or date of use of the restricted zone, and cumulative time through which the restricted zone is driven is transmitted via HEO to the center. <3> Settlement methods are post batch billing, on-the-spot payment by ETC, and prepayment.

The data providing service for nonlife insurance companies will be described. This is concerned with a service to provide nonlife insurance companies with information for calculating premium rates and share of liability in accidents of all the data stored through the information collection, processing, and analysis functions described in the foregoing flow chart (S14). <1> A service can be provided, in which insurance premiums are paid only for the time band through which the vehicle is used. Possible payment methods for the on-demand insurance (designed for those drivers who do not drive vehicles often, for weekend drivers; low-premium insurance without having to make an annual contract) include deferred payment for a predetermined period of time (e.g., one month), on-the-spot payment by ETC card, and settlement by card at the end of driving, in addition to the conventional advance payment. <2> Insurance premiums are calculated by classifying the route, discriminating between a frequently driven road and a completely new one, and between whether the vehicle moves through an accident-ridden spot and one with almost no accident. To ensure right to privacy, information on longitude and latitude is not necessarily provided and, instead, the on-board device may be used to determine the foregoing discrimination and a corresponding code is transmitted. For instance, a road which has not been driven for the past one year is 0, a road otherwise classified is 1, and the vehicle's traveling past an accident-ridden spot is 2; and, it is not necessary to provide information on when and where the vehicle has traveled.

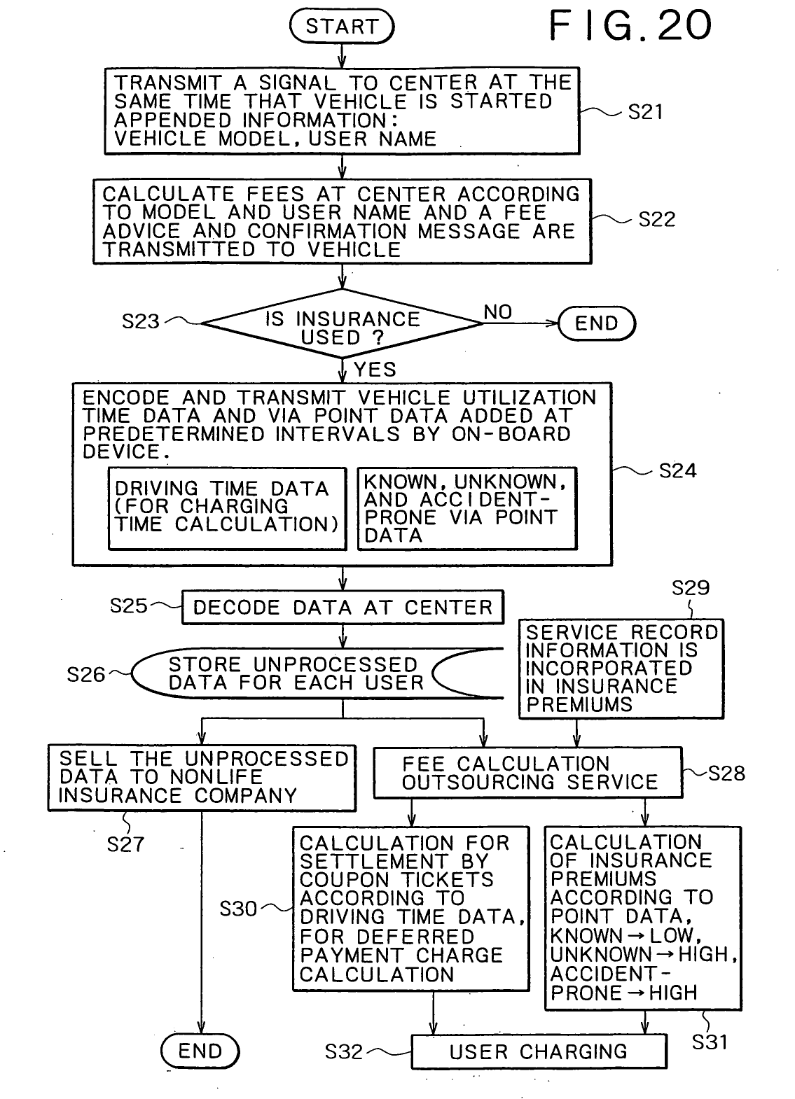

The vehicle information providing service for nonlife insurance companies will be described in detail with reference to the flowchart shown in FIG. 20. Like the foregoing examples, a music/image distribution contract has been concluded with the controlled vehicle in question.

<1> Immediately after the driver or user has inserted the key and started the engine, a start signal is automatically transmitted from the vehicle to the centralized management center (S21). This starts collecting (1) vehicle position information, (2) vehicle control information, and (3) vehicle parts condition information according to the flow shown in FIG. 16. In the meantime, the applicable vehicle model, user name, and other types of attached information in addition to the foregoing information are separately collected and analyzed at the centralized management center as described earlier.

<2> Fees are calculated at the center according to the vehicle model and user name and fee advice and a confirmation message are transmitted to the vehicle (S22). The user of the vehicle is prompted to determine whether he or she wants to use the insurance (S23). In this example, the user's intention to use the insurance or not is inquired through the vehicle, thereby concluding the contract on the spot; however, needless to say it is possible to conclude the contract in advance, in which case, validity for a predetermined period of time can be set up for the contract. In addition, the validity may be on a short term as in this example and it could be a specific date only or the number of days according to an itinerary. In this example, the validity is considered to be a predetermined period of time, as it is stipulated in the contract.

<3> When the user's intention to use the insurance is transmitted, vehicle utilization time data and via point data, which are added up at predetermined intervals, are encoded and transmitted by the on-board device (S24). Measurement of data can be taken continuously instead of at predetermined intervals. In this case, recording through data collection may be limited only to unique events. In the example, driving time data is obtained and used for calculating the charging time. Depending on the specific details of the contract, the charging time may be all or part of the total driving time. In addition, via point data of known, unknown, and accident-ridden spots through which the vehicle moves are also collected. These spots may be registered by the central management system at the center or confirmed that they are yet to be registered. It is further possible to make other driving or vehicle information available in electronic form. It may for example be possible to collect frequency data of sudden braking, abrupt steering, and sudden starts and total acceleration value data of each of these items. Instead of a spot, an area including that spot may be used. The description hereunder is concerned with spots. These pieces of data are decoded at the center (S25) and stored as unprocessed data for each user (S26). That is, unprocessed data are stored for nonlife insurance companies, fee calculation outsourcing service companies, and users.

<4> The collected data is used for sale of unprocessed data to nonlife insurance companies (S27) and provided for fee calculation outsourcing service companies (S28). In the meantime, service record information in the form of data is separately provided for the fee calculation outsourcing service companies so that it is incorporated in calculation of insurance premiums (S29). Such information as the past periodic inspection and service records is collected, including, for example, the number of days elapsed since the last service maintenance job. The information is collected by letting the vehicle send a transmission if it is provided with a memory, or by letting the vehicle maintenance service companies send it over the network.

<5> The fee calculation outsourcing service company calculates the charging time based on the driving time data, validates it, and makes a calculation for settlement by coupon tickets and a calculation for deferred payment. It also makes a calculation of insurance premiums according to via point data by setting a low premium rate for known spots, a high premium rate for unknown spots, and a high premium rate for accident-ridden spots. This setting is referred to, in this specification, as weighting of insurance premiums. It goes without saying that, instead of a premium rate for basic insurance premiums, the insurance premiums themselves may be calculated.

For a contracted vehicle, driving time for a predetermined period of time is collected and via point data representing points through which the contracted vehicle has been driven (including traveled routes and areas as described earlier) is collected; charging time data is established based on the driving time data and a weighting of insurance premiums is established based on the charging time data or via point data, or both, thereby calculating and displaying the amount charged as insurance premiums based on the charging time data, via point data, and insurance premium weighting. It is of course possible to calculate points acquired from the driving time data and the number of specific points driven through, based on which the amount charged as insurance premiums is calculated. Even with this approach, a time to be charged is set for calculation and a points count is set using via point data, which serves as adopting weighting for insurance premiums. For the purpose of the weighting of insurance premiums, one or a combination of the following types of information may be used: vehicle control information, vehicle parts condition information, vehicle (e.g., whether it is new or old) and user information, and maintenance and historical information.

<6> Charging to users is processed according to the amount charged as insurance premiums (S32). For example, the sum is debited from the user's account through the aforementioned card according to a deferred payment system. This charging to users includes charging of insurance premiums for PL (product liability) for the vehicle or parts manufacturers and charging of insurance premiums based on an analysis made of the share of liability in accidents.

Thanks to a statistical analysis of vehicle condition information made possible through the positive and proper information collection system, it is possible to review and revise the amount of insurance premiums at the time of contract renewal, as changed from the existing advance payment method.

When the invention is embodied in vehicle insurance, it is possible to statistically identify the frequency and condition of utilization of vehicles on a real-time basis, which makes possible charging of insurance premiums in accordance with the frequency and condition of utilization of vehicles. This diversifies the form of insurance contract, without being limited to payment of premiums on an annual contract. For example, it permits deferred payment of insurance premiums.

More specifically, outlined condition information of vehicles that run throughout Japan is centrally managed at the center using HEO and, through an additional and tie-up use of DSRC, IMT-2000, or other broadband mobile communications system, detailed condition information is also gathered. Then, mining of this data is carried out and a service is rendered to provide charged information.

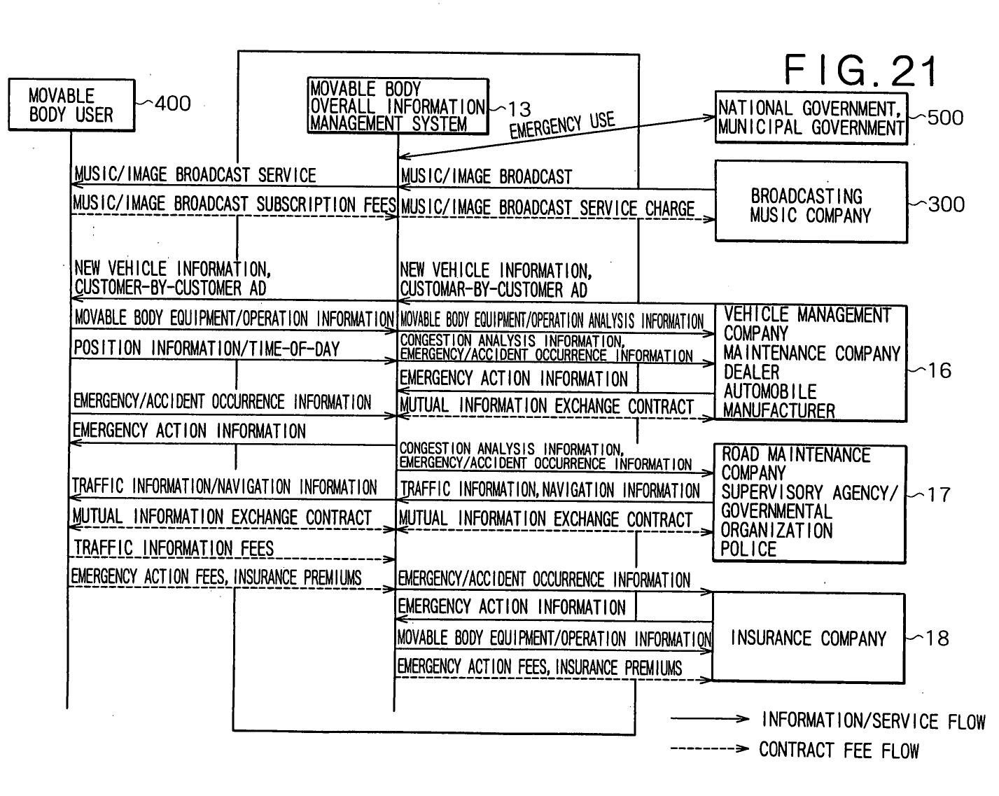

FIG. 21 shows a flow of information services and contract fees in a basic business of “music/broadcast+interactive communication.”

In compliance with a contract concluded among a movable body user 400 owning a vehicle 4, a broadcasting music company (a company distributing broadcasts and music) 300, and a movable body overall information management system management company 13, music and/or image are broadcast for the movable body overall information management system 13 and a music/image broadcast service is provided from the movable body overall information management system management company 13 to the movable body user 400. In payment for the service, the movable body user 400 pays a music/broadcast subscription fee to the movable body overall information management system 13 which, in turn, pays a music/broadcast fee to the broadcasting music company 300. In this invention, the management company may collect the subscription fees from a large number of users and pays the broadcasting music company the total sum all together.

Various methods are possible for payment of fees which may be entrusted with a finance company or made into bank accounts. According to the invention, the movable body user receives music and image as the basic service, for which the user pays a subscription fee. In the meantime, the invention allows the same device as the receiver (that is, the receiver is to be used as a transmitter/receiver) to transmit information at predetermined intervals, of which the movable body user may or may not be aware. The management system is therefore allowed to analyze the transmitted information, thus adding value to it to create a new form of service for a greater convenience to the movable body user and, at the same time, added room for an increase in the subscription fee.

The management company collects subscription fees from movable body users and pays the total sum all together as a content providing fee to the broadcasting music company. The management company therefore assumes risks of collecting subscription fees and finding subscribers to pay the broadcasting music company a predetermined amount of broadcast/music content providing fees. The basic function of the broadcasting music company is to provide content and therefore the broadcasting music company means a broadcast and music content provider. The overall management company owns a satellite to establish an uplink (according to the preferred embodiment of the invention, though there may be another company involved through which the uplink is established). To sum up, it is the aim of the invention to enhance convenience of the service by having a single terminal both for receiving broadcast and music and sending transmission. A mutual information exchange contract is also concluded between an insurance company and a system company. That is, a user is entitled to a reduction in insurance premiums if he or she is found to seldom apply sudden brake as judged from daily driving habits. Information is transmitted automatically without the driver's knowing it as he or she listens to a broadcast or music during driving and information collected from a large number of drivers is then analyzed.

Based on the broadcast contract described in the foregoing being concluded, a vehicle management company 16 (maintenance company, dealer, automobile manufacturer, etc.) provides the user 400 with new vehicle information and customer-by-customer advertisements by way of the movable body overall information management system 13. The user 400 provides the movable body overall information management system management company 13 with movable body equipment operating information, position and time-of-day information, and emergency/accident occurrence information. From the management company 13, the movable body equipment operating information is transmitted as movable body equipment/operation analysis information and the position and time-of-day information is transmitted as congestion analysis information and emergency/accident occurrence information to the vehicle management company 16. From the vehicle management company 16, emergency action information is provided for the corresponding user by way of the overall information management system management company 13 and, from the overall information management system management company, emergency action information is provided for the movable body user 400. A mutual information exchange contract is concluded between the overall information management system 13 and the vehicle management company 16.

There is also concluded a mutual information exchange contract between a road maintenance company 17 (including a supervisory agency, governmental organization, and police) and the movable body overall information management system management company 13. Traffic information and navigation information are provided from the road maintenance company 17 to the system management company 13, while congestion analysis information and emergency/accident occurrence information are provided from the system management company 13 to the road maintenance company 17. Moreover, emergency action information is provided from the insurance company 18 to the system management company 13, while emergency/accident occurrence information and movable body equipment/operation information are provided from the system management company 13 to the insurance company 18. The system management company 13 pays the insurance company 18 emergency action fees and insurance premiums.

The traffic information and navigation information provided by the road maintenance company 17 are distributed to the movable body user 400 by the system management company 13. This service is based on, as a prerequisite, a mutual information exchange contract previously concluded between the user 400 and the system management company 13 and the user 400 is to pay the system management company 13 traffic information fees, and the insurance company 18 via the system management company 13 emergency action fees and insurance premiums. A method is also available, in which the emergency action fees and insurance premiums are paid directly to the insurance company and it is also the scope of this invention that commission is added when the payment is made through the system management company. Furthermore, it is allowed that various types of information are used in emergencies within the movable body overall information management system management company 13 and a national government and municipal government 500.

As apparent from the foregoing description, since a vehicle, which is driven by a driver who has concluded a contract to subscribe to sound or image information by means of interactive communications via a satellite, is provided with the probe car function according to the invention, traffic control can be provided smoothly and public actions of various kinds and insurance actions can be taken by deriving information from vehicle owners. The invention also provides convenience, with which the movable body user is provided with appropriate services in return for information provided by the user even without his or her knowing it.

While a preferred embodiment of the invention has been described using specific terms, such description if for illustrative purposes only, and it is to be understood that changes and variations may be made without departing from the spirit or scope of the following claims.

1. A vehicle managing method comprising the steps of:
distributing music and/or image through a satellite to each of vehicles with which a contract for music distribution and/or image distribution has been made;
receiving periodic information on each of the contracted vehicles therefrom via the satellite and analyzing the received information for each vehicle; and,
transmitting the analysis information to a predetermined recipient of the analysis information.

2. A vehicle managing method comprising the steps of:
distributing through a satellite information in one category, or two or more categories, selected from among music, image, navigation, road and traffic, emergency, and new vehicle information categories to each of vehicles with which a contract for music distribution and/or image distribution has been made;
receiving periodic information on each of the contracted vehicles therefrom via the satellite and analyzing the received information for each vehicle; and,
transmitting the analysis information to a predetermined recipient of the analysis information.

3. A vehicle managing method according to claim 1 or 2, wherein the periodic information is on at least one of the position, speed, direction, and conditions of the vehicle.

4. A vehicle managing method according to claim 1 or 2, wherein emergency information concerning the vehicle is also transmitted in addition to the periodic information transmitted to the satellite from each of the contracted vehicles.

5. A vehicle managing method according to claim 1 or 2, wherein the recipient of the analysis information is selected from among groups of an insurance company, a road maintenance company, a supervisory agency, a governmental organization, a vehicle management company, a vehicle maintenance company, and a vehicle dealer.

6. A vehicle managing method according to claim 1 or 2, wherein the satellite is a non-geostationary satellite that is in an elliptic orbit.

7. A vehicle managing method according to claim 1, wherein the information transmitted from the vehicle at a periodic interval is stored in a storage medium at an interval shorter than the periodic interval and the stored information is transmitted in a batch at the periodic interval.

8. A vehicle managing method comprising the steps of:
distributing music and/or image through a satellite to each of vehicles with which a contract for music distribution and/or image distribution has been made;
receiving periodic information on each of the contracted vehicles therefrom via the satellite and analyzing the received information for each vehicle; and
transmitting the analysis information to a predetermined recipient of the analysis information; wherein the periodic information comprises driving time data and via point data representing geographical points, areas, or routes through which the vehicle has traveled.

9. A vehicle managing method according to claim 1, 2, or 8, wherein vehicle position information is found and collected by using a signal reflected off an artificial satellite after the signal has been transmitted thereto through an antenna provided in a controlled vehicle, and information on a condition of each individual vehicle is collected by transmitting vehicle control information or vehicle parts condition information from the controlled vehicle to the artificial satellite through the antenna provided in the controlled vehicle and receiving a signal reflected off the artificial satellite or by transmitting the information by way of DSRC (dedicated short range communication) or a mobile communications device including a cellular phone and receiving the transmitted signal.

10. A vehicle managing method according to claim 1, 2, or 8, wherein vehicle position information is found and collected by using a signal reflected off an artificial satellite after the signal has been transmitted thereto through an antenna provided in a controlled vehicle, information on a condition of each individual vehicle is collected by transmitting vehicle sensor information to the artificial satellite through the antenna provided in the controlled vehicle and receiving a signal reflected off the artificial satellite or by transmitting the information by way of DSRC (dedicated short range communication) or mobile communications device including a cellular phone and receiving the transmitted signal, and individual vehicle information is collected together with a vehicle model, serial number, and other vehicle body information as well as user information unique to the controlled vehicle separately input.

11. A vehicle managing method according to claim 1, 2, or 8, wherein vehicle position information is found and collected by using a signal reflected off an artificial satellite after the signal has been transmitted thereto through an antenna provided in a controlled vehicle, information on a condition of each individual vehicle is collected by transmitting vehicle control information or vehicle parts condition information from the controlled vehicle to the artificial satellite through the antenna provided in the controlled vehicle and receiving a signal reflected off the artificial satellite or by transmitting the information by way of DSRC (dedicated short range communication) or a communications device including a cellular phone and receiving the transmitted signal, and individual vehicle information is collected by transmitting vehicle condition information extracted from a diagnostics system mounted in the controlled vehicle, based on a command issued by the diagnostics system to transmit diagnostics results information, from the controlled vehicle to the artificial satellite and receiving a signal reflected therefrom, together with vehicle body information including a vehicle model, serial number, as well as user information unique to the controlled vehicle separately input.

12. A vehicle managing method according to claim 1, 2, or 8. wherein information on a condition of each individual vehicle is collected by transmitting vehicle control information or vehicle parts condition information from a controlled vehicle to an artificial satellite through an antenna provided in the controlled vehicle and receiving a signal reflected off the artificial satellite.

13. A vehicle managing method according to claim 1, 2, or 8, wherein information on a condition of each individual vehicle is collected by transmitting vehicle sensor information to an artificial satellite through an antenna provided in a controlled vehicle and receiving a signal reflected off the artificial satellite, and individual vehicle information is collected together with vehicle body information including a vehicle model, and serial number, as well as user information unique to the controlled vehicle separately input.

14. A vehicle managing method according to claim 1, 2, or 8, wherein information on a condition of each individual vehicle is collected by transmitting vehicle control information and vehicle parts condition information from a controlled vehicle to an artificial satellite through an antenna provided in the controlled vehicle and receiving a signal reflected off the artificial satellite and by transmitting vehicle condition information extracted from a diagnostics system mounted in the controlled vehicle, based on a command issued by the diagnostics system to transmit diagnostics results information, from the controlled vehicle to the artificial satellite and receiving a signal reflected therefrom, together with vehicle body information including a vehicle model and serial number, as well as user information unique to the controlled vehicle separately input. To provide a vehicle overall interactive managing method by allowing vehicle information to be provided for an information requiring organization and, at the same time, providing a vehicle user with sound and image information.
